(19) United States
(12) Patent Application Publication
(10) Pub. No.: US 2009/0109331 A1
(43) Pub. Date: Apr. 30, 2009

(54) PORTABLE DEVICE AND IMAGING DEVICE

(75) Inventors: Ryo Imai, Kurokawa-gun (JP); Kazuhisa Horikiri, Minato-ku (JP); Masayuki Sakai, Minato-ku (JP); Noriko Katayama, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/261,125

(22) Filed: Oct. 30, 2008

(30) Foreign Application Priority Data
Oct. 31, 2007 (JP) 2007-284078

(51) Int. Cl. H04N 5/225

(52) U.S. Cl. 348/376; 348/E05.001

(57) ABSTRACT

An aspect of the present invention provides a portable device having a first enclosure and a second enclosure, comprising: a joint device which slidably joints the first enclosure and the second enclosure, and which enables a first operation of slidably moving the first enclosure between a first position and a second position in a same plane and enables a second operation of rotatably moving the first enclosure around a predetermined axis in the same plane based on a reference position of at least one of the first position and the second position; and an instruction input device which inputs an instruction to the portable device based on at least the second operation of the first enclosure.

### BACKGROUND OF THE INVENTION

1. Field of the Invention

The present invention relates to a portable device and an imaging device, and more particularly to a portable device having two enclosures that are slidably jointed, and an imaging device.

2. Description of the Related Art

There has been known a camera having a lens barrier which covers a front of the lens when the camera is not used, and opens the front of the lens to make the lens usable when the camera is used. The lens barrier serves to protect the lens and often serves as a switch for controlling the power ON/OFF of the camera. As the lens barrier having further another function, Japanese Patent Application Laid-Open No. 2007-33996 discloses a camera in which a lens protection member serving as a lens barrier is movable to a plurality of positions and a different function is allocated to an operation unit depending on an individual position thereof. According to this technique, a plurality of functions can be allocated to one operation unit depending on the position of the lens barrier, thereby suppressing an increase in the number of parts.

Moreover, Japanese Patent Application Laid-Open No. 2002-90863 discloses a camera in which a front main portion of the lens barrier is detachably configured as an outside barrier member, and the outside barrier member functions as a remote controller for remotely controlling the camera main body. Such a configuration assures that the lens can be protected when the camera is not in use, and the camera can be used as remote controller when the camera is in use. In addition, the remote controller can be prevented from being lost while the camera is being carried.

The original purpose of the lens barrier is to protect the lens when not in use, and preferably the lens barrier should stop at one of the position of protecting the lens and the position of exposing the lens to be used. Such a configuration assures that, after the camera is used, the lens can be protected simply by moving the lens barrier from a current position to an opposite position.

### SUMMARY OF THE INVENTION

However, according to Japanese Patent Application Laid-Open No. 2007-33996, when the lens barrier is movable to a plurality of positions, a visual inspection is needed to confirm the position at which the lens barrier stopped. Moreover, when a plurality of functions are allocated to one operation unit, the number of parts can be reduced, but there is another problem in that it is difficult and troublesome for the user to find which function corresponds to which position of the lens barrier.

Moreover, Japanese Patent Application Laid-Open No. 2002-90863 has a disadvantage in that, since the front main portion of the lens barrier is detachably configured as an outside barrier member, there is a possibility that the outside barrier member is removed from the camera when not in use and the lens cannot be properly protected.

In view of such circumstances, the present invention has been made, and an object of the present invention is to provide a portable device and an imaging device which not only can protect the lens when not in use, but also can perform camera operation by changing the position of an enclosure such as a lens barrier when in use.

In order to achieve the above object, a first aspect of the present invention provides a portable device having a first enclosure and a second enclosure, comprising: a joint device which slidably joints the first enclosure and the second enclosure, and which enables a first operation of slidably moving the first enclosure between a first position and a second position in a same plane and enables a second operation of rotatably moving the first enclosure around a predetermined axis in the same plane based on a reference position of at least one of the first position and the second position; and an instruction input device which inputs an instruction to the portable device based on at least the second operation of the first enclosure.

Thereby, an easy-to-operate portable device can be provided.

According to a second aspect of the present invention, in the portable device according to the first aspect, the joint device can joint self-returnably to the reference position after the second operation of rotary movement.

Thereby, an easy-to-operate portable device can be provided.

According to a third aspect of the present invention, in the portable device according to the first or second aspect, the joint device further comprises a device which stops the first enclosure and the second enclosure at the first position and at the second position with a predetermined holding force.

Thereby, an easy-to-operate portable device at each position can be provided.

According to a fourth aspect of the present invention, the portable device according to any of the first to third aspects further comprises a position detection device which detects whether the first enclosure is located at the first position or the second position, wherein the instruction input device inputs an instruction to the portable device based on a detection result of the position detection device.

Thereby, a different function at each position can be allocated.

According to a fifth aspect of the present invention, the portable device according to any of the first to fourth aspects further comprises a device which detects a rotating direction of the second operation, wherein the instruction input device inputs an instruction to the portable device based on the detected rotating direction.

Thereby, a different function in a different rotating direction can be allocated.

According to a sixth aspect of the present invention, the portable device according to the fifth aspect further comprises a device which detects a rotation amount of the second operation, wherein the instruction input device inputs an instruction to the portable device based on the detected rotation amount.

Thereby, a different function can be allocated based on the rotation amount.

According to a seventh aspect of the present invention, in the portable device according to the sixth aspect, the instruction input device inputs an instruction to the portable device so as to change a speed of a function of operating based on the detected rotation amount.

Thereby, the operation speed of a function can be changed based on the rotation amount.

According to an eighth aspect of the present invention, in the portable device according to the sixth aspect, the instruction input device inputs an instruction to the portable device so as to change a function of operating based on the detected rotation amount.

Thereby, a different function can be allocated based on the rotation amount.

In order to achieve the above object, a ninth aspect of the present invention provides an imaging device comprising: the portable device according to any of the first to eighth aspects, wherein the second enclosure is provided with a photographic lens; and the photographic lens is covered with the first enclosure at the first position and is exposed at the second position.

Thereby, the photographic lens can be protected.

According to a tenth aspect of the present invention, the imaging device according to the ninth aspect further comprises a position detection device which detects whether the first enclosure is located at the first position or at the second position, wherein, when the first position is detected, the instruction input device inputs an instruction related to an image reproduction, and when the second position is detected, the instruction input device inputs an instruction related to an image photographing.

Thereby, in no photographing mode, the lens can be protected, and further, an operation related to image reproduction can be performed.

According to an eleventh aspect of the present invention, the imaging device according to the ninth aspect further comprises a position detection device which detects whether the first enclosure is located at the first position or at the second position, wherein, when the first position is detected, power supplied to the imaging device is turned off.

Thereby, when the power supply is turned off, the photographic lens can be protected.

According to the present invention, the lens and other parts can be protected when not in use, and various operations such as a camera operation can be performed by moving the lens barrier and other enclosures.

### BRIEF DESCRIPTION OF THE DRAWINGS

FIGS. 1A, 1B, and 1C are external views of a digital camera 1 of a first embodiment in accordance with the present invention, each illustrating a state in which the silhouettes of a first enclosure 10, a second enclosure 20, and a third enclosure 30 thereof are overlapped and located at a first position. FIG. 1A is a front view; FIG. 1B is a side view; and FIG. 1C is a rear view. They illustrate a state in which the first enclosure 10 and the third enclosure 30 are moved parallel from the first position to a second position;

FIGS. 2A, 2B and 2C are external views of the digital camera 1, each illustrating a state in which the first enclosure 10 and the third enclosure 30 are moved parallel from the first position to a second position. FIG. 2A is a front view; FIG. 2B is a side view; and FIG. 2C is a rear view;

FIG. 3 is an exploded perspective view of the essential portions of the digital camera 1;

FIG. 4 is a perspective view of a joint mechanism seen through from the front side of the first enclosure 10 at a position where the first enclosure 10, the second enclosure 20, and the third enclosure 30 thereof are located at the first position;

FIG. 5 is a perspective view of the joint mechanism seen through from the front side of the first enclosure 10 at a position where the first enclosure 10, the second enclosure 20, and the third enclosure 30 thereof are located at the second position;

FIG. 6A is a sectional view illustrating a state in which a stick switch 31 is attached to an attachment portion 11 formed on the rear surface of the first enclosure 10; and FIG. 6B is a perspective view of the attachment portion 11;

FIG. 7A is a drawing illustrating a state in which a stick 31a is rotated clockwise; and FIG. 7B is a drawing illustrating a state in which a stick 31a is rotated counterclockwise;

FIG. 8 is an exploded perspective view of the essential portions of the digital camera 2 of a second embodiment in accordance with the present invention;

FIG. 9 is a drawing illustrating a normal state in which the first enclosure 10 and the third enclosure 30 are overlapped;

FIG. 10 is a drawing illustrating a state in which the first enclosure is rotated clockwise from the normal state;

FIG. 11 is a drawing illustrating a state in which the first enclosure 10 is rotated counterclockwise from the normal state;

FIG. 12 is a drawing illustrating a modification in which push switches 36 and 37 are removed from the first embodiment;

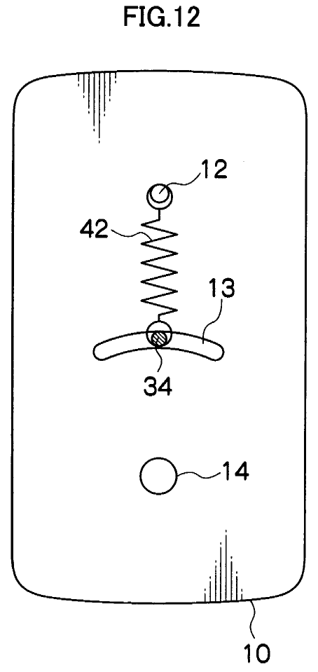

FIG. 13 is a drawing illustrating a joint mechanism;

FIG. 14 is a drawing illustrating a state in which the first enclosure 10 shown in FIG. 13 is rotated counterclockwise;

FIG. 15 is a drawing illustrating a state in which the silhouettes of the first enclosure 50, the second enclosure 60, and the third enclosure 70 are overlapped and located at the first position;

FIG. 16 is a drawing illustrating a state in which the first enclosure 50, the second enclosure 60, and the third enclosure 70 are moved parallel from the first position to the second position;

FIG. 17 is an exploded perspective view of the essential portions of the mobile phone 3;

FIG. 18 is a sectional view illustrating a state in which the first enclosure 50, the second enclosure 60, and the third enclosure 70 are located at the first position;

FIG. 19 is a sectional view illustrating a state in which the first enclosure 50, the second enclosure 60, and the third enclosure 70 are being moved from the first position to the second position;

FIG. 20 is a sectional view illustrating a state in which the first enclosure 50, the second enclosure 60, and the third enclosure 70 are located at the second position;

FIGS. 21A, 21B, and 21C are perspective views, each illustrating a state in which the first enclosure 50 is in swing operation;

FIGS. 22A, 22B, and 22C are perspective views, each illustrating a state in which the first enclosure 50 is in swing operation;

FIG. 23 is an external view illustrating an example in which the first enclosure 10 is moved parallel in the obliquely lower left direction viewed from the front thereof;

FIGS. 24A and 24B are external views, each illustrating an example in which the first enclosure 10 is moved parallel in the downward direction viewed from the front thereof;

FIG. 25 is a block diagram illustrating an embodiment of an internal configuration of the digital camera 1;

FIG. 26 is a flowchart showing an operation of the digital camera 1;

FIG. 27 is a drawing illustrating an example of a circuit diagram in which the stick switch 31 is used as a volume switch and outputs a current flow according to a rotation angle;

FIGS. 28A and 28B are drawings, each illustrating a relation between a swing angle and the current flow;

FIG. 29 is a block diagram illustrating an embodiment of an internal configuration of the digital camera 2;

FIG. 30 is a block diagram illustrating an embodiment of an internal configuration of the mobile phone 3;

FIG. 31 is a flowchart showing an operation related to the swing operation of the mobile phone 3; and

FIGS. 32A, 32B and 32C are external views, each illustrating an example in which the digital camera 1 is moved at the first position by a swing operation in the counterclockwise direction viewed from the rear thereof.

### DETAILED DESCRIPTION OF THE PREFERRED EMBODIMENTS

Hereinafter, the preferred embodiments for carrying out a portable device in accordance with the present invention will be described in detail with reference to the accompanying drawings.

### First Embodiment

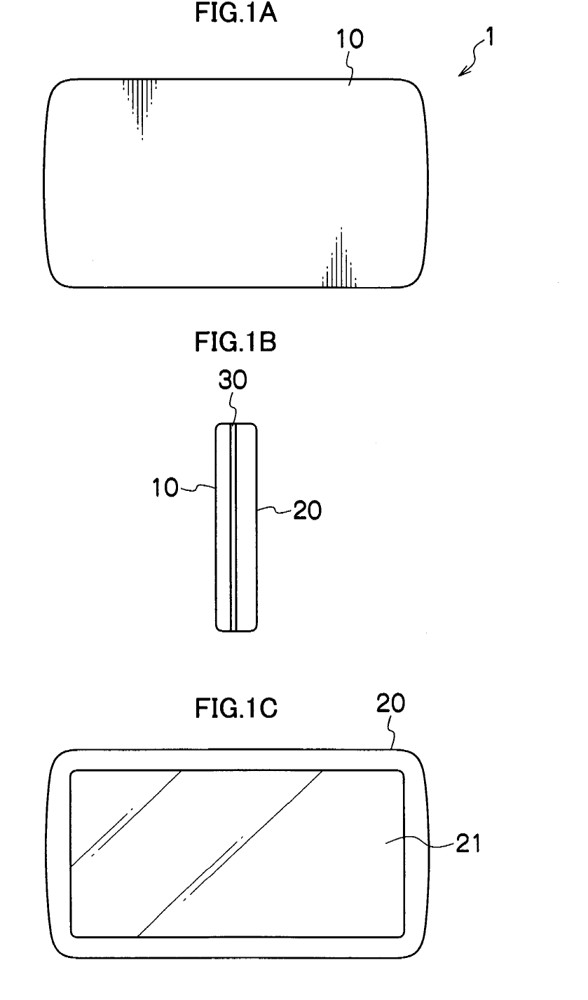

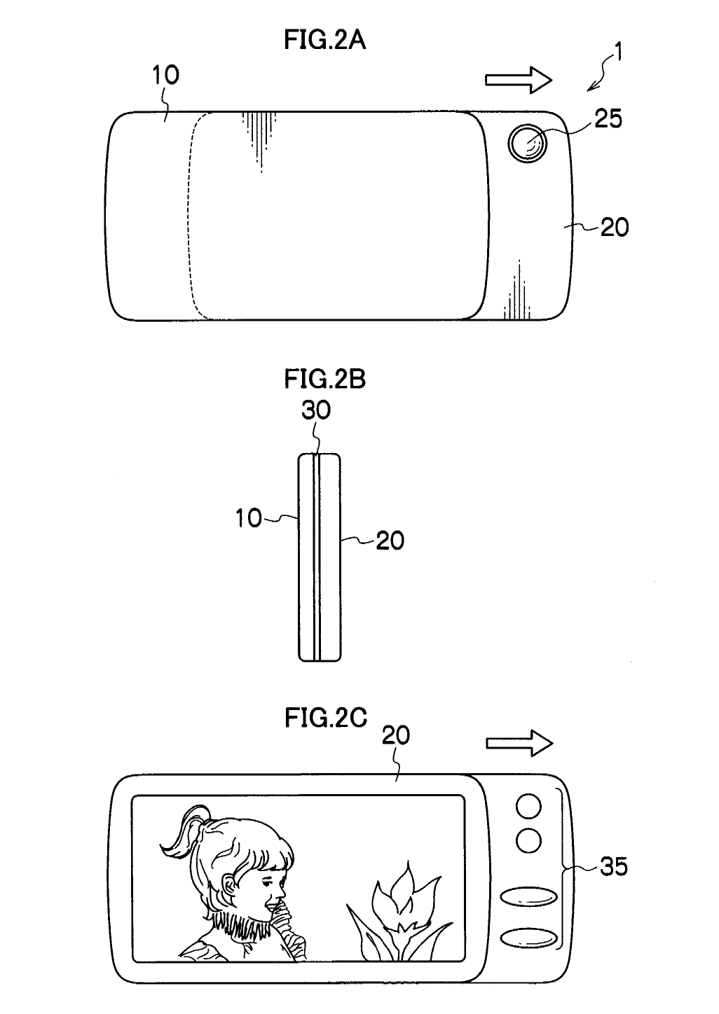

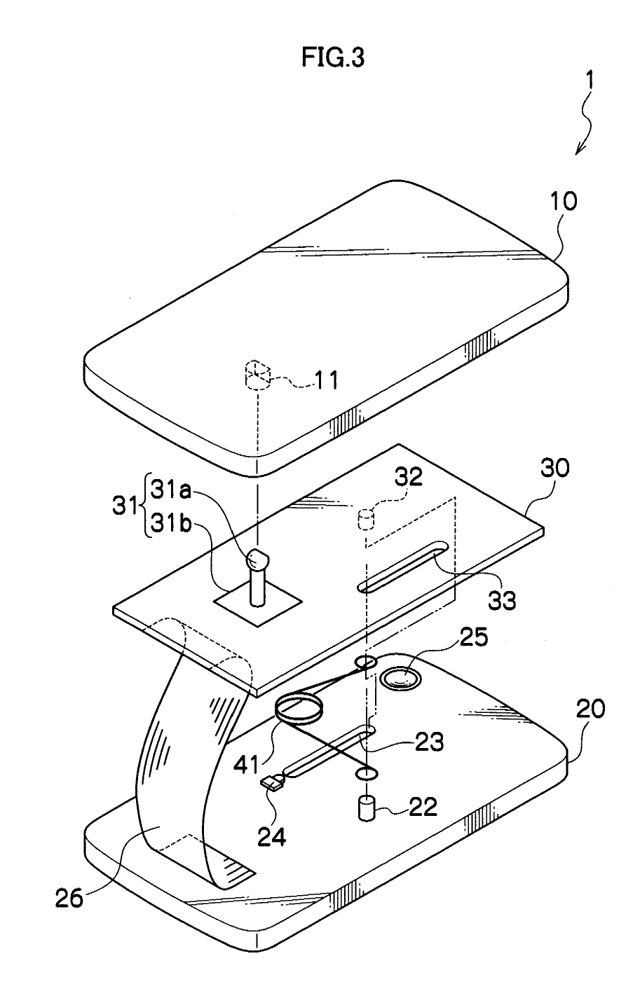

FIGS. 1 and 2 are external views of a digital camera 1 of a first embodiment in accordance with the present invention, in which FIGS. 1A and 2A are front views; FIGS. 1B and 2B are side views; and FIGS. 1C and 2C are rear views. FIG. 1 illustrates a state in which the silhouettes of a first enclosure 10, a second enclosure 20, and a third enclosure 30 are overlapped and located at a first position; and FIG. 2 illustrates a state in which the first enclosure 10, the second enclosure 20, and the third enclosure 30 are moved parallel from the first position to a second position. FIG. 3 is an exploded perspective view of the essential portions of the digital camera 1.

The digital camera 1 is mainly composed of the first enclosure 10, the second enclosure 20, and the third enclosure 30. As shown in FIG. 1, the first position indicates a storage state in which the operation unit is not exposed. As shown in FIG. 2, the second position indicates a use state in which a photographic lens 25 provided on the front side of the second enclosure 20 and an operation unit 35 provided on the front side of the third enclosure 30 are exposed, and photographing and other operation are enabled.

The first enclosure 10 is a substantially rectangular plate shaped member, and is used a lens barrier. The attachment portion 11 (detailed later) for attaching the stick switch 31 fixed to the third enclosure 30 is provided on the rear side of the first enclosure 10. When the stick switch 31 is attached to the first enclosure 10 through the attachment portion 11, the first enclosure 10 is assembled so as to be integral with the third enclosure 30.

The second enclosure 20 is a substantially rectangular plate shaped member having almost the same size as the first enclosure 10, and as shown in FIGS. 1 and 2, a monitor 21 is mainly provided on the rear side thereof. Moreover, as shown in FIG. 3, a boss 22, an elongated hole 23, a push switch 24, the photographic lens 25, a flexible printed wiring board 26, and the like are mainly provided on the front side of the second enclosure 20.

The third enclosure 30 is a substantially rectangular plate shaped member having a slightly smaller size than the first enclosure 10 and the second enclosure 20; and as shown in FIGS. 3, the stick switch 31 is mainly provided on the front side thereof; and the boss 32 and the elongated hole 33 are mainly provided on the rear side thereof.

The monitor 21 is composed of a liquid crystal display capable of color display. The monitor 21 is used in a reproduction mode not only as an image display panel for displaying a photographed image but also as a user interface display panel for performing various setting operations. Moreover, in a photographing mode, a through image is displayed as needed, and the monitor 21 is used as an electronic finder for confirming the image angle.

The push switch 24 is a switch which is turned on when the tip thereof is pressed.

The photographic lens 25 is composed of a bending type zoom lens.

The flexible printed wiring board 26 is arranged such that one end thereof is jointed to a circuit board or the like (not shown) provided inside the second enclosure 20 and the other end thereof is jointed to a circuit board or the like (not shown) provided inside the third enclosure 30.

As shown in FIG. 3, the stick switch 31 is composed of a stick 31a having a substantially spherical shaped tip, and a switch unit 31b for detecting a motion of the stick 31a. The stick 31a can be rotated both clockwise and counterclockwise. Moreover, the switch unit 31b can detect a rotating operation and a rotating direction of the stick 31a. The stick switch 31 is configured such that the stick 31a is normally located at a center position. The stick 31a can be rotated about 45 degrees in each direction by a rotating operation to stop at that position. When an external force is removed after the rotating operation, the stick 31a is configured to be automatically returned to the center position.

### (About the Movement Between the First Position and the Second Position)

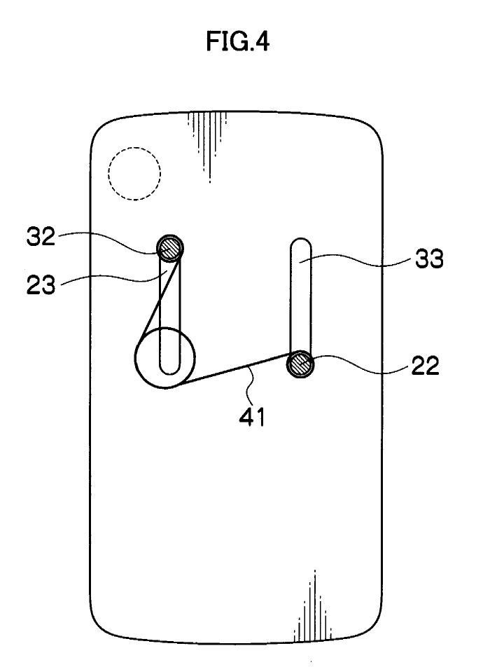

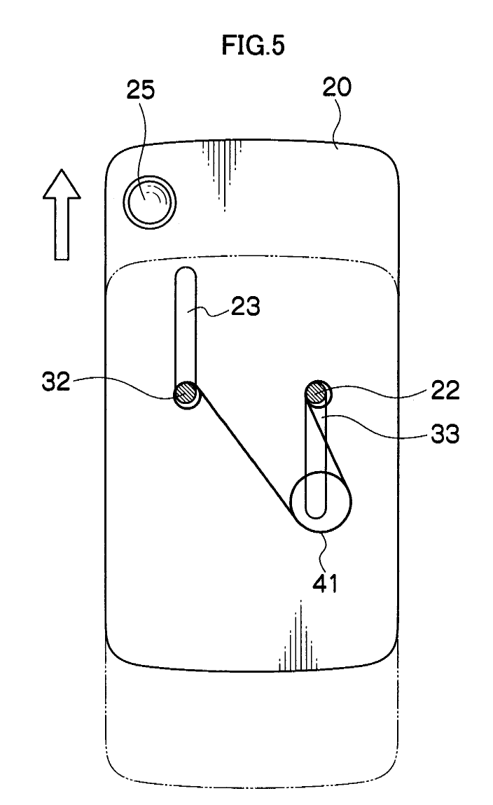

The joint mechanism for movably jointing the first enclosure 10 and the third enclosure 30; and the second enclosure 20 will be described. FIG. 4 is a perspective view of the joint mechanism seen through from the front side of the first enclosure 10 at a position where the first enclosure 10, the second enclosure 20, and the third enclosure 30 thereof are located at the first position; FIG. 5 is a perspective view of the joint mechanism seen through from the front side of the first enclosure 10 at a position where the first enclosure 10, the second enclosure 20, and the third enclosure 30 thereof are located at the second position.

First, the configuration of the joint mechanism will be described. As shown in FIG. 3, the joint mechanism is composed of the boss 22, the elongated hole 23, and the push switch 24 provided on the second enclosure 20; and the boss 32, the elongated hole 33, and the spring 41 provided on the third enclosure 30.

The each end of the spring 41 is rotatably inserted into the bosses 22 and 32; the boss 22 can slide inside the elongated hole 33; and the boss 32 can slide inside the elongated hole 33.

The hole diameters of the elongated holes 23 and 33 are larger than those of the bosses 22 and 32 so as to be interlocked with each other.

The push switch 24 is provided at the left endpoint of the elongated hole 33. When the boss 32 comes in contact with the push switch 24, the push switch 24 detects whether the first enclosure 10, the second enclosure 20, and the third enclosure 30 are located at the first position or at the second position.

The spring 41 is a coil spring for urging a force in the unwinding direction, and both ends thereof have a round shape. One end of the spring 41 is rotatably inserted into the boss 22; and the other end thereof is rotatably inserted into the boss 32.

Each end of the spring 41 is inserted into the boss 22 and the boss 32. Then, the boss 22 is inserted into the elongated hole 33 and the boss 32 is inserted into the elongated hole 23. Subsequently, a pin, a screw, or the like (not shown) is attached to the front edge of the boss 22 so as to prevent the boss 22 from being removed from the elongated hole 33; and a pin, a screw, or the like (not shown) is attached to the front edge of the boss 32 so as to prevent the boss 32 from being removed from the elongated hole 23. Thereby, the first enclosure 10 and the third enclosure 30 are movably jointed to the second enclosure 20.

Next, the method for moving the first enclosure 10, the second enclosure 20, and the third enclosure 30 between the first position and the second position will be described.

As shown in FIG. 4, at the first position, the boss 22 is located at the left endpoint of the elongated hole 33; and the boss 32 is located at the right endpoint of the elongated hole 23. The spring 41 urges a force against the first enclosure 10 and the third enclosure 30 in the right direction viewed from the front thereof. However, since the boss 22 is located at the left end point of the elongated hole 33, the first enclosure 10 and the third enclosure 30 cannot be moved further in the right direction. In other words, the first enclosure 10 and the third enclosure 30 are fixed to the first position.

When, at the first position, the first enclosure 10 and the third enclosure 30 are moved in the left direction against the urging force of the spring 41, the boss 22 slides in the left direction along inside the elongated hole 33 and the boss 32 slides in the left direction along inside elongated hole 23. In other words, the first enclosure 10 and the third enclosure 30 move parallel to the left side over-the surface of the second enclosure 20; and the first enclosure 10, the second enclosure 20, and the third enclosure 30 move from the first position to the second position.

As shown in FIG. 5, at the second position, the boss 22 is located at the right endpoint of the elongated hole 33; and the boss 32 is located at the left endpoint of the elongated hole 23. The spring 41 urges a force against the first enclosure 10 and the third enclosure 30 in the left direction viewed from the front thereof. However, since the boss 22 is located at the right end point of the elongated hole 33, the first enclosure 10 and the third enclosure 30 cannot be moved further in the left direction. In other words, the first enclosure 10 and the third enclosure 30 are fixed to the second position.

Moreover, at the second position, the boss 32 turns on the push switch 24 and then, it is detected that the first enclosure 10, the second enclosure 20, and the third enclosure 30 are located at the second position.

When, at the second position, the first enclosure 10 and the third enclosure 30 are moved in the right direction against the urging force of the spring 41, the boss 22 slides in the right direction along inside the elongated hole 33 and the boss 32 slides in the right direction along inside elongated hole 23. In other words, the first enclosure 10 and the third enclosure 30 move parallel to the right side over the surface of the second enclosure 20; and the first enclosure 10, the second enclosure 20, and the third enclosure 30 return from the second position to the first position.

### (About the Operation of the First Enclosure 10)

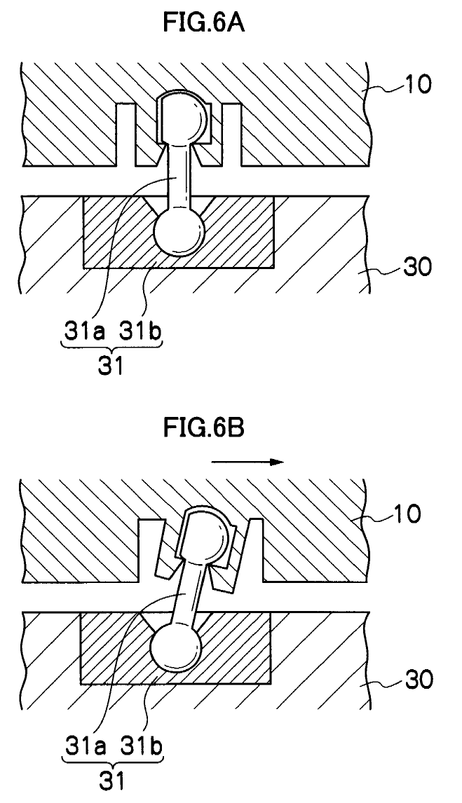

The first enclosure 10 can be subjected to a rotating operation clockwise and counterclockwise at the first position and at the second position. Hereinafter, the structure and the operation of the first enclosure 10 located at the second position will be described. FIG. 6A is a sectional view illustrating a state in which the stick switch 31 is attached to the attachment portion 11 formed on the rear surface of the first enclosure 10; and FIG. 6B is a perspective view of the attachment portion 11.

As shown in FIG. 6A, the substantially spherical shaped front end portion of the stick 31a is formed into a substantially D-shape viewed from above so as not to be rotated when attached to the attachment portion 11.

As shown in FIG. 6B, the attachment portion 11 is composed of four elastic nails. As shown in FIG. 6A, the internal space formed by the four nails is formed into a substantially D-shape in the same manner as for the substantially spherical shaped front end portion of the stick 31a so as to be fit into the front end of the stick 31a.

When the attachment portion 11 is placed on the front end of the stick 31a and an external force is applied thereto from above the first enclosure 10, the four nails of the attachment portion 11 are bent so as to fit the attachment portion 11 into the front end of the stick 31a. Thereby, the first enclosure 10 is attached to the third enclosure 30 through the stick switch 31. The integrally formed first enclosure 10 and third enclosure 30 move between the first position and the second position.

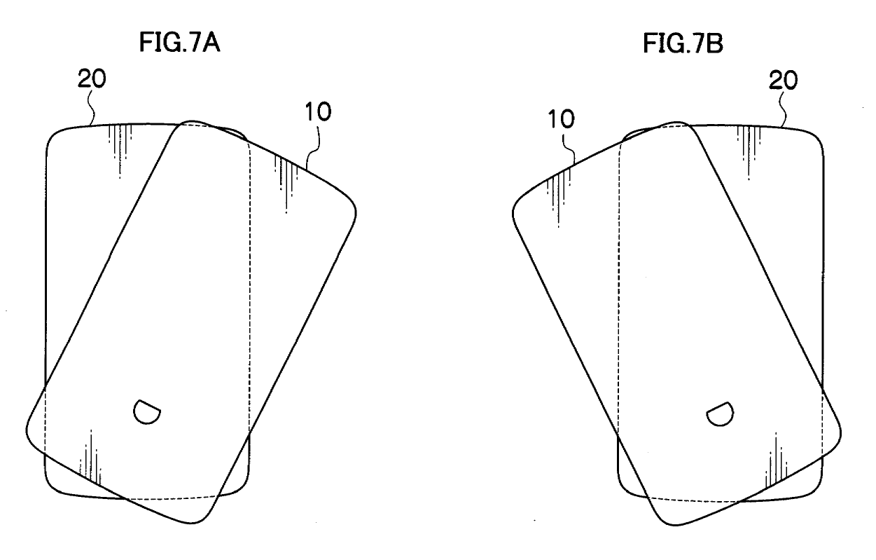

At the same time, when an external force is applied to the first enclosure 10, the stick switch 31 can be rotated clockwise and counterclockwise. Hereinafter, the method for operating the first enclosure 10 will be described. FIG. 7A illustrates a state in which the stick 31a is rotated clockwise; and FIG. 7B illustrates a state in which the stick 31a is rotated counterclockwise.

When a clockwise external force is applied to the first enclosure 10, as shown in FIG. 7A, the stick 31a is rotated clockwise around the stick 31a. Subsequently, when the clockwise external force applied to the first enclosure 10 is removed, the stick 31a is automatically returned to the center position. In other words, the first enclosure 10 returns to the normal state in which the first enclosure 10 and the third enclosure 30 are overlapped.

It should be noted that since the third enclosure 30 is smaller than the first enclosure 10, the third enclosure 30 cannot be seen while the first enclosure 10 is being moved by the rotating operation.

### (About the Internal Structure)

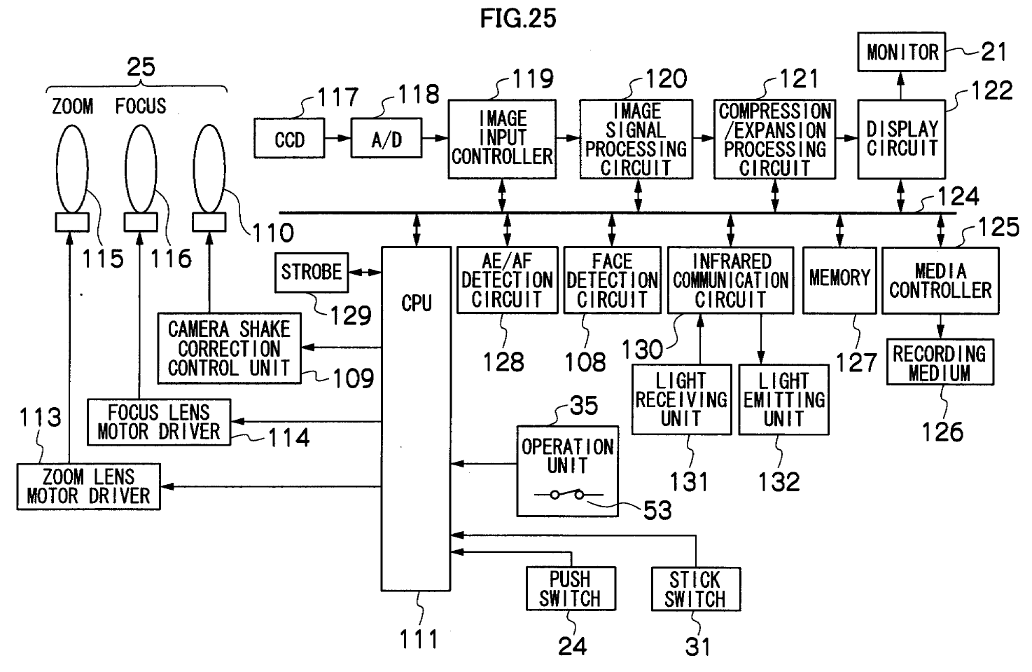

FIG. 25 is a block diagram illustrating an embodiment of an internal configuration of the digital camera 1.

As shown in the figure, the digital camera 1 of the present embodiment is configured to include a CPU 111, an operation unit 35, a zoom lens motor driver 113, a focus lens motor driver 114, a camera shake correction control unit 109, a zoom lens 115, a focus lens 116, a camera shake correction lens 110, a CCD 117, an A/D converter 118, an image input controller 119, an image signal processing circuit 120, a compression/expansion processing circuit 121, a display circuit 122, a monitor 21, a media controller 125, a recording medium 126, a memory 127, an AE/AF detection circuit 128, a face detection circuit 108, a strobe 129, an infrared communication circuit 130, a push switch 24, a stick switch 31 and the like.

An individual unit is controlled and operated by the CPU 111. The CPU 111 controls the individual unit of the digital camera 1 by executing a predetermined control program based on an input from the operation unit 35.

The CPU 111 incorporates a program ROM, which stores not only a control program to be executed by the CPU 111, but also various kinds of data required for control and the like. The CPU 111 controls the individual unit of the digital camera 1 by sequentially executing the control program.

The operation unit 35 includes a power button 53, a shutter button (not shown), and the like and outputs a signal according to the operation to the CPU 111.

The photographic lens 25 is configured to include the zoom lens 115, and the focus lens 116, and the camera shake correction lens 110.

The zoom lens 115 is driven by the zoom lens motor driver 113 and moves back and forth along the optical axis of the focus lens 116. The CPU 111 controls the movement of the zoom lens 115 for zooming by controlling the drive of the zoom lens motor through the zoom lens motor driver 113.

The focus lens 116 is driven by the focus lens motor driver 114 moves back and forth along the optical axis of the zoom lens 115. The CPU 111 controls the movement of the focus lens 116 for focusing by controlling the drive of the focus lens motor (not shown) through the focus lens motor driver 114.

The camera shake correction lens 110 is controlled by the camera shake correction control unit 109. The camera shake correction control unit 109 uses a gyro sensor to detect a shake of digital camera 1 and moves the camera shake correction lens 110 in a direction opposite to the shake direction to correct the camera shake of an object image to be photographed through the zoom lens 115 and the focus lens 116.

The CCD 117 is provided at the rear stage of the camera shake correction lens 110 and receives object light transmitted through the zoom lens 115, the focus lens 116, and the camera shake correction lens 110. As is well known, the CCD 117 is provided with a light receiving surface on which a large number of light receiving elements are arranged in a matrix. The object light transmitted through the zoom lens 115 and the focus lens 116 is focused on the light receiving surface of the CCD 117 and then is converted to an electrical signal by the individual light receiving element.

The CCD 117 outputs a charge accumulated on an individual pixel one by one line as a serial image signal in synchronism with a vertical transfer clock and a horizontal transfer clock.

As described above, when the digital camera 1 is set to the photographing mode, the output of an image signal is started, and the through image is displayed on the monitor 21. When a photography instruction is given, the output of the image signal for the through image is temporarily stopped; and when the photographing is terminated, the output thereof is resumed.

Moreover, when needed in the photographing, the CPU 111 instructs the strobe 129 to be emitted as a photographing auxiliary light.

The image signal outputted from the CCD 117 is an analog signal, and the analog image signal is fed into the A/D converter 118.

The A/D converter 118 is configured to include a correlative double sampling (CDS) circuit and an automatic gain control (AGC) circuit. The CDS circuit removes noise from an image signal and the AGC circuit amplifies the noise-removed image signal by a predetermined gain. The AID converter 118 further converts the analog image signal into a digital image signal having a predetermined number of bits of gradation width. The image signal is a so-called RAW data having gradation values corresponding to density values of R, G, and B for each pixel.

The image input controller 119 incorporates a predetermined number of line buffers, and accumulates one frame of image signal outputted from the A/D converter 118 therein. The one frame of image signal accumulated in the image input controller 119 is stored in the memory 127 through a bus 124.

The bus 124 connects to not only the CPU 111, the image input controller 119, the memory 127 described above, but also the image signal processing circuit 120, the compression/expansion processing circuit 121, the display circuit 122, the media controller 125, the AE/AF detection circuit 128, the strobe 129, the infrared communication circuit 130, and the like; and these components are configured to send and receive information to and from each other through the bus 124.

The one frame of image signal stored in the memory 127 is fed into the image signal processing circuit 120 in a dot sequential manner (in the order of pixels).

The image signal processing circuit 120 performs a predetermined signal process on the color image signals of R, G, and B which are fed in a dot sequential manner to generate an image signal (Y/C signal) consisting of a luminance signal Y and color difference signals Cr and Cb.

In response to an instruction from the CPU 111, the AE/AF detection circuit 128 fetches the image signals of R, G, and B stored in the memory 127 through the image input controller 119 and calculates a focus evaluated value required for AF (Automatic focus) control. The AE/AF detection circuit 128 includes a highpass filter for passing only the high-frequency component of the G signal; an absolute value converter; a focus region extraction unit for extracting a signal within a predetermined focus region set on the screen; and an integrator for integrating absolute value data within the focus region; and outputs the absolute value data within the focus region integrated by the integrator, to the CPU 111 as the focus evaluated value. During AF control, the CPU 111 searches for a position where the focus evaluated value outputted from the AE/AF detection circuit 128 becomes maximum; and moves the focus lens 116 to that position so as to focus on a major object to be photographed.

Moreover, in response to an instruction from the CPU 111, the AE/AF detection circuit 128 fetches the image signals of R, G, and B stored in the memory 127 through the image input controller 119 and calculates a focus evaluated value required for AE control. More specifically, the AE/AF detection circuit 128 divides a photographing region (one screen) into a plurality of regions, and calculates an integration value of the individual image signal of R, G, and B for each region. The information about the integrated value of the individual image signal of R, G, and B calculated for each divided region is stored in the memory 127.

The CPU 111 calculates an exposure value from the integrated value calculated by the AE/AF detection circuit 128 and performs exposure setting based on the exposure value. The exposure setting is to determine a diaphragm value and a shutter speed according to a predetermined program diagram.

The face detection circuit 108 detects a face region of a person from the image signal stored in the memory 127. In order to detect the face region, first, a predetermined number of resized images each having a different resolution are prepared for the image to be detected. Next, a region where one or more face images match the predetermined sized face image prepared in advance of a plurality of face images is extracted from all the individual resized images. Then, a resized image having a maximum number of extracted regions is selected, the extracted region within the selected resized image is scaled up or down to fit the size of the image before resized, and then, the obtained region is determined as a face to be photographed. Finally, the number of detected face regions, the coordinate, and the size are outputted.

In response to a compression instruction from the CPU 111, the compression/expansion processing circuit 121 performs a predetermined type of compression process (e.g., JPEG) on the image signal (Y/C signal) consisting of the inputted luminance signal Y and color difference signals Cr and Cb to generate compressed image data. In addition, in response to an expansion instruction from the CPU 111, the compression/expansion processing circuit 121 performs a predetermined type of expansion process on the inputted compressed image data to generate uncompressed image data.

In response to an instruction from the CPU 111, the display circuit 122 controls displaying on the monitor 21. More specifically, in response to an instruction from the CPU 111, the display circuit 122 converts an image signal sequentially inputted from the memory 127 into a video signal (e.g., an NTSC signal, a PAL signal, or a SCAM signal) to be displayed on the monitor 21 and outputs the signal to the monitor 21. Moreover, the display circuit 122 combines a signal such as a character, a graphic, a symbol, and the like to be displayed on the monitor 21 as needed, into an image signal so as to display a predetermined character, graphic, symbol, and the like on the monitor 21.

In response to an instruction from the CPU 111, the media controller 125 controls reading and writing data to and from the recording medium 126. It should be noted that the recording medium 126 may be detachable from the camera body like a memory card or may be incorporated in the camera body. When a detachable recording medium is used, a card slot is provided in the camera body and the recording medium is inserted into the card slot to be used.

In response to an instruction from the CPU 111, the infrared communication circuit 130 performs infrared communication with an external device. The infrared communication circuit 130 modulates data to be sent and sends the modulated data from the light emitting unit 132 to an external device. Moreover, the infrared communication circuit 130 uses the light receiving unit 131 to receive data sent from an external device and modulates the received signal.

As described above, the push switch 24 detects the first position and the second position of the digital camera 1. The push switch 24 outputs a signal according to the ON/OFF state thereof. The CPU 111 can analyze the output signal to detect the first position and the second position.

Moreover, the stick switch 31 detects a rotating operation of the first enclosure 10. The stick switch 31 outputs a signal according to the direction of the rotating operation. The CPU 111 can analyze the output signal to confirm the direction of the rotating operation.

### (About Operation)

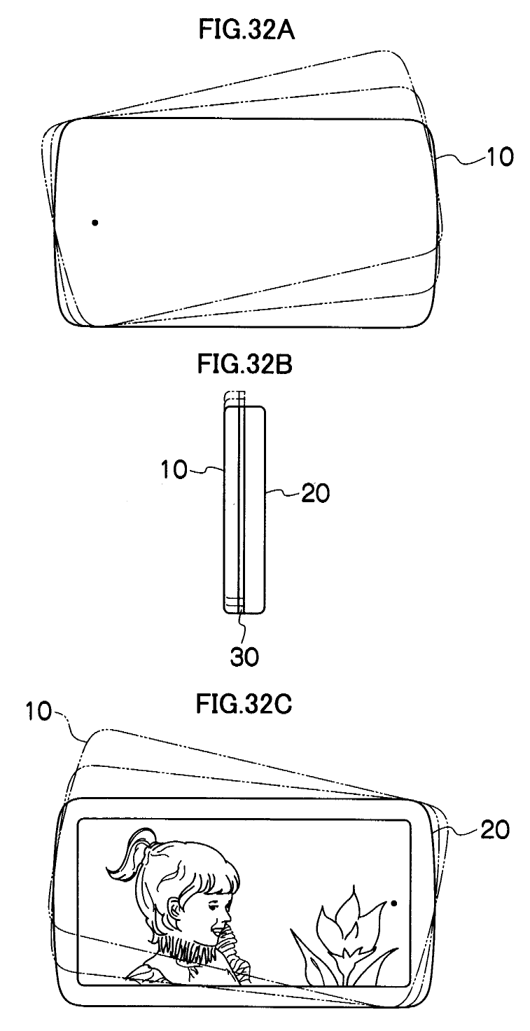

Hereinafter, the operation of the digital camera 1 of the present embodiment configured as above will be described. When the power is turned on by operating, the power button 53, the digital camera 1 is ready for operation. In a state where the power is turned on, when the digital camera 1 is moved to the first position, the reproduction mode is selected; and when the digital camera 1 is moved to the second position, the photographing mode is selected. Here, the user can perform a clockwise or counterclockwise rotating operation of the stick switch 31 by applying an external force to the first enclosure 10 at each position so as to operate the camera functions. It should be noted that the clockwise or counterclockwise rotating operation of the stick switch 31 by applying an external force to the first enclosure 10 is hereinafter referred to as a swing operation of the first enclosure 10. FIGS. 32A, 32B, and 32C are external views, each illustrating an example in which the digital camera 1 is moved at the first position by a swing operation in the counterclockwise direction viewed from the rear thereof.

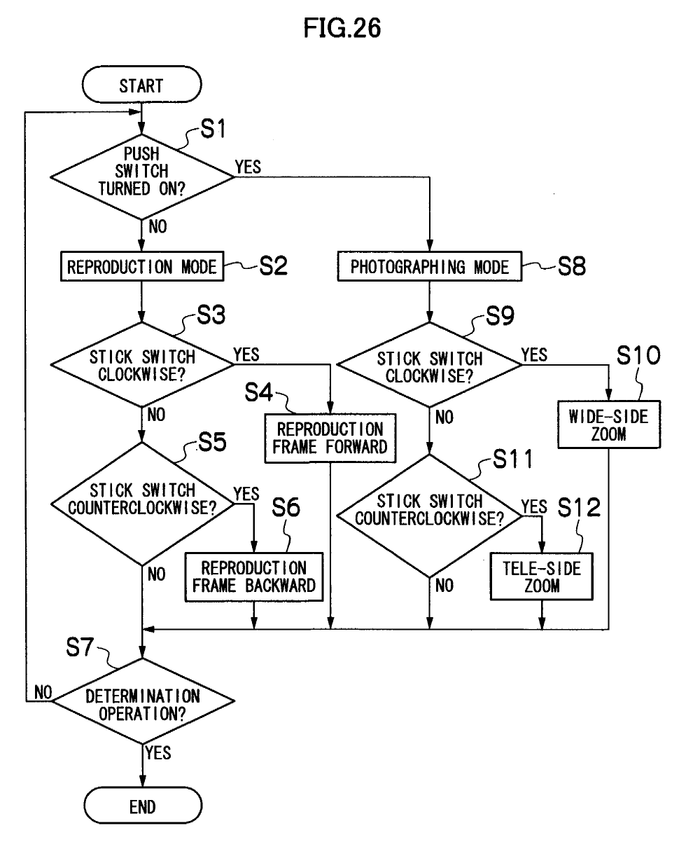

Next, the operation of the digital camera 1 of the present embodiment will be described with reference to the flowchart of FIG. 26.

When the power button 53 is turned on and the power to the digital camera 1 is turned on, first, a determination is made as to whether the push switch 24 is turned on or not (step S1). If a determination is made that the push switch 24 is turned on, the CPU 111 determines that the digital camera 1 is located at the second position and sets to the photographing mode (step S8). If a determination is made that the push switch 24 is turned off, the CPU 111 determines that the digital camera 1 is located at the first position and sets to the reproduction mode (step S2). By doing so, the CPU 111 switches the operation mode according to the state of the push switch 24.

First, the operation in the reproduction mode will be described.

When set to the reproduction mode, an image file of the last frame recorded in the recording medium 126 is read out through the media controller 125. The compressed data of the read image file is expanded into an uncompressed YC signal through the compression/expansion processing circuit 121.

The display circuit 122 converts the expanded YC signal into a display signal format to be outputted to the monitor 21. Then, the image of the last frame recorded in the recording medium 126 is displayed on the monitor 21.

In this state, when the user performs a swing operation on the first enclosure 10 in the clockwise direction viewed from the rear thereof, the stick 31 a of the stick switch 31 is rotated in the clockwise direction viewed from the rear thereof. Then, the switch unit 31b detects that the stick 31a is rotated in the clockwise direction viewed from the rear thereof. Then, the stick switch 31 outputs a signal corresponding to the rotation in the clockwise direction viewed from the rear thereof. The CPU 111 analyzes the signal outputted from the stick switch 31, and detects the occurrence of a clockwise swing operation viewed from the rear thereof (step S3). Further, based on the detection result, the image signal processing circuit 120 is used to perform a frame feeding operation in the forward direction on the image displayed on the monitor 21 (step S4). Then, an image file at the frame fed position is read out from the recording medium 126 and the image is reproduced on the monitor 21 in the same manner as described above.

Moreover, when the user performs a swing operation on the first enclosure 10 in the counterclockwise direction viewed from the rear thereof, the stick 31a of the stick switch 31 is rotated in the counterclockwise direction viewed from the rear thereof. Then, the switch unit 31b detects that the stick 31a is rotated in the counterclockwise direction viewed from the rear thereof. Then, the stick switch 31 outputs a signal corresponding to the rotation in the counterclockwise direction viewed from the rear thereof. The CPU 111 analyzes the signal outputted from the stick switch 31, and detects the occurrence of a counterclockwise swing operation viewed from the rear thereof (step S5). Further, based on the detection result, the image signal processing circuit 120 is used to perform a frame feeding operation in the backward direction on the image displayed on the monitor 21 (step S6). Then, an image file at the frame fed position is read out from the recording medium 126 and the image is reproduced on the monitor 21.

In this state, when an enter key (not shown) is used to select a displayed image, the selected image can be sent by infrared communication.

Next, the operation in the photographing mode will be described.

As described above, when set to the photographing mode, a through image is displayed on the monitor 21. In this state, when the user performs a swing operation on the first enclosure 10 in the clockwise direction viewed from the rear thereof, the stick switch 31 is rotated in the clockwise direction viewed from the rear thereof and outputs a signal corresponding to the rotation. The CPU 111 detects the signal outputted from the stick switch 31 (step S9), and performs a zooming operation to the wide side by driving the zoom lens 115 through the zoom lens motor driver 113 (step S10).

Moreover, when the user performs a swing operation on the first enclosure 10 in the counterclockwise direction viewed from the rear thereof, the stick switch 31 is rotated in the counterclockwise direction viewed from the rear thereof (step S11) and outputs a signal corresponding to the rotation. The CPU 111 detects the signal outputted from the stick switch 31, and performs a zooming operation to the tele side by driving the zoom lens 115 through the zoom lens motor driver 113 (step S12).

In this state, the camera is ready for photographing at a desired zoom factor using a shutter button (not shown).

The allocation of a swing operation to a function is not limited to the present embodiment, but the swing operation may be allocated to any function. For example, in the reproduction mode, the clockwise swing operation may be allocated to the forward frame feeding, and the counterclockwise swing operation may be allocated to the infrared communication.

According to the present embodiment, when the external force applied to the first enclosure 10 is removed after a swing operation of the first enclosure 10, the stick 31a is automatically returned to the center position, and at the same time, the first enclosure 10 is also returned to the normal state where the first enclosure 10 and the third enclosure 30 are overlapped, but the present invention is not limited to this automatic return. For example, the stick 31a may be configured to be manually returned to the original sate. Such a configuration allows the swing state to be held after the swing operation. Therefore, for example, when a frame is fed in the reproduction mode, a continuous frame feeding can be easily performed.

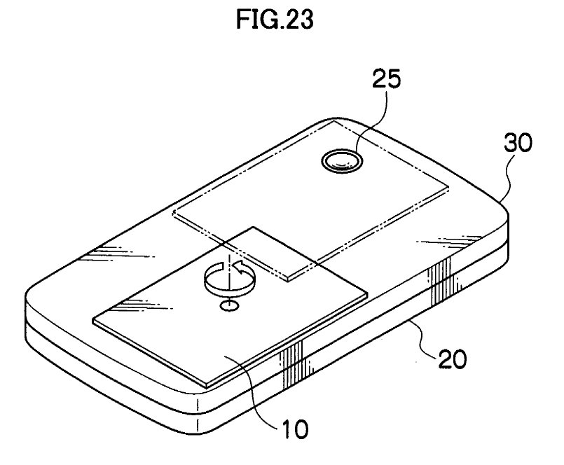

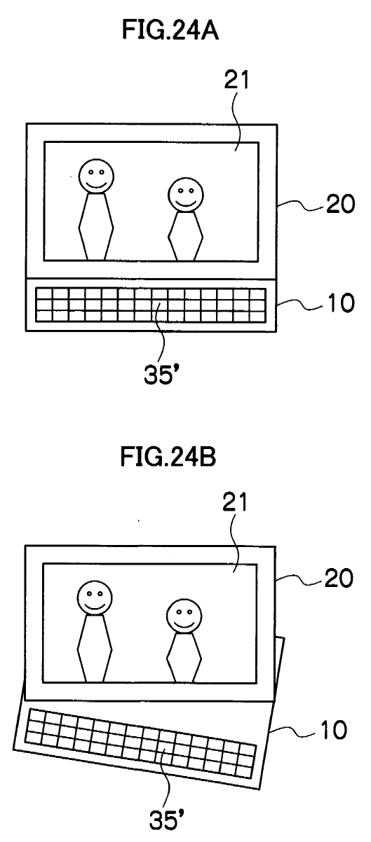

Moreover, according to the present embodiment, the first enclosure 10 is moved from the first position to the second position by parallel moving the first enclosure 10 in the left direction viewed from the front thereof, but the direction of the parallel movement is not limited to the left, and any direction including the right, upward, downward, or oblique direction may be possible. For example, FIG. 23 is an external view illustrating an example in which the first enclosure 10 is moved parallel in the obliquely lower left direction viewed from the front thereof. Moreover, FIG. 24A is an external view illustrating an example in which the first enclosure 10 is moved parallel in the downward direction viewed from the front thereof. FIG. 24B is an external view illustrating an example in which the first enclosure 10 is swung from the state illustrated in FIG. 24A. In FIGS. 24A and 24B, a key board 35′ is exposed as the operation unit 35, which may be used as a mobile personal computer, a game console, or the like.

Alternatively, a configuration may be made such that the stick switch 31 is used as a volume switch, and a current flow is outputted according to the swing angle of the swing operation, namely, the rotation angle of the stick switch 31 so that the operation speed of a function may be changed according to the current flow.

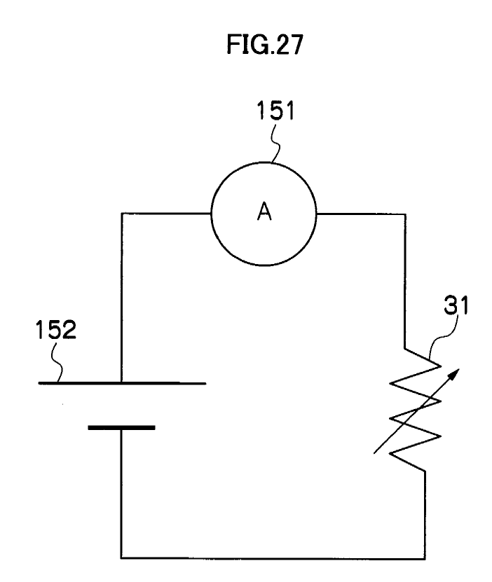

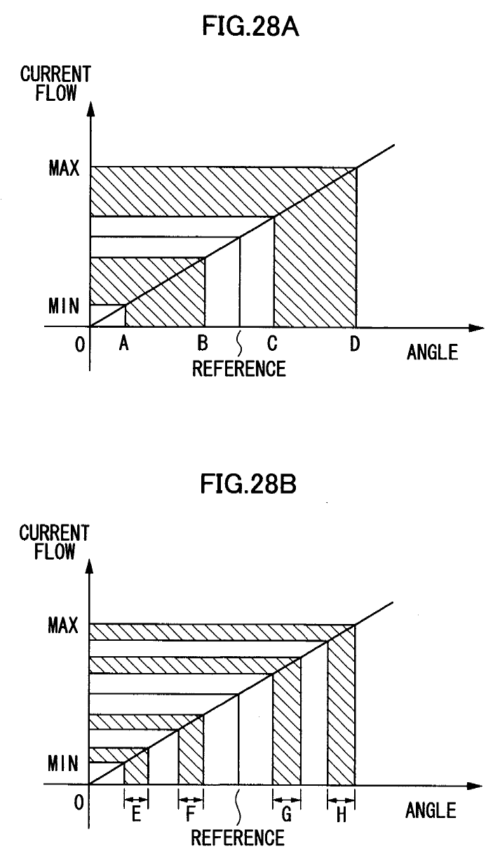

FIG. 27 illustrates an example of a circuit diagram in which the stick switch 31 is used as a volume switch and outputs a current flow according to the rotation angle thereof. The stick switch 31 is configured such that a resistance value thereof is changed according to the rotation angle thereof. A constant-voltage source 152 is jointed to both ends of the variable resistor, and further an amperemeter 151 is jointed in tandem thereto. When the stick switch 31 is rotated, the resistance value is changed, and the amount of current flowing through the amperemeter 151 is changed. FIGS. 28A and 28B are drawings, each illustrating a relation between the swing angle and the current flow.

As shown in FIG. 28A, the clockwise rotatable angle of the stick switch 31 is assumed to be 0 to D. Here, when a wide zoom operation is performed by a swing operation from angle C to angle D, the closer to angle D, the higher the zooming speed. In contrast to this, the counterclockwise rotatable angle of the stick switch 31 is assumed to be 0 to A. Here, when a tele zoom operation is performed by a swing operation from angle B to angle A, the closer to angle A, the higher the zooming speed. The CPU 111 controls the zooming speed according to the input current flow. Alternatively, in the case of feeding a frame of an image to be reproduced, a configuration may be made such that the closer to angle D of the swing operation, the higher the frame feeding speed.

As described above, the CPU 111 can change the operation speed of a function according to the rotation angle of the swing operation by detecting the current flow.

Alternatively, as shown in FIG. 28B, a different function may be allocated to a swing angle of the swing operation, namely, the current flow. In the Figure, the swing angle is divided into a G region indicating a small amount of clockwise rotation; an H region indicating a large amount of clockwise rotation; an F region indicating a small amount of counterclockwise rotation; and an E region indicating a large amount of counterclockwise rotation. The region is determined according to the current flow detected by the CPU 111. For example, in the reproduction mode, a function may be allocated to a region such that the backward frame feeding is allocated to the F region; the forward frame feeding to the G region; the infrared communication to the H region; the image data display to the E region, and the like.

Moreover, according to the present embodiment, the first enclosure 10 is swung, various settings are determined according to the signal outputted from the stick switch 31, and then, the operation is controlled for each mode based on the determined settings, but the present invention is not limited to this. For example, after the first enclosure 10 is swung, various settings are determined by pushing the first enclosure 10 in the depth direction (push operation), and then, the operation may be controlled for each mode based on the determined settings. It should be noted that this operation needs the use of the stick switch 31 in which the switch unit 31b can detect that the stick 31a is pushed. The stick switch 31 is configured such that when the external force is removed after the push operation, the stick 31a is automatically returned to the reference position.

Alternatively, the stick switch 31 may detect further four directional movements (shift operation) in addition to the swing operation by configuring a retractable switch having a four directional resolution such as the upward, downward, left, and right directions in addition to the rotation direction. In this case, the stick switch 31 may preferably be configured such that when the external force is removed after the shift operation, the stick 31a is automatically returned to the reference position.

### Second Embodiment

According to the first embodiment, the stick switch 31 is used to perform and detect the clockwise or counterclockwise rotating operation on the first enclosure 10, but the method for the rotating operation and detection is not limited to this.

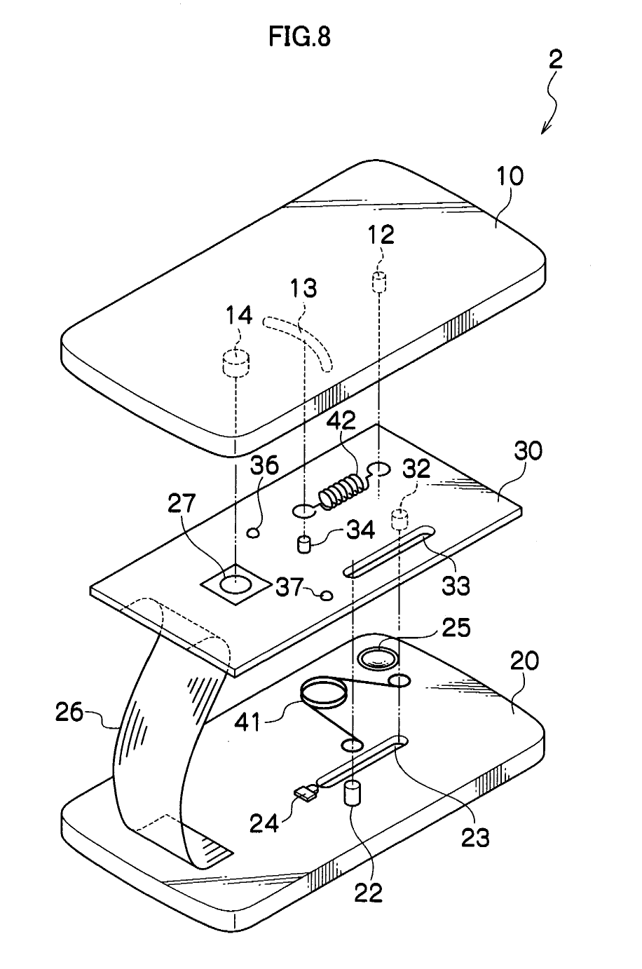

The second embodiment uses a hinge and a spring to enable the rotating operation. FIG. 8 is an exploded perspective view of the essential portions of the digital camera 2 of the second embodiment in accordance with the present invention. It should be noted that the same reference numerals as in the first embodiment are assigned to the same portions and the descriptions thereof are omitted. In addition, the movement between the first position and the second position is the same as in the first embodiment and the description thereof is omitted

The digital camera 2 is mainly composed of the first enclosure 10, the second enclosure 20, and the third enclosure 30. The second enclosure 20 is the same as that in the first embodiment and the description thereof is omitted.

The first enclosure 10 is made of a substantially rectangular plate member and is used as a lens barrier. A boss 12, an arc shaped elongated hole 13, and a shaft 14 are provided on the rear side of the first enclosure 10.

The third enclosure 30 is made of a substantially rectangular plate member equal to or smaller than the first enclosure 10. As shown in FIG. 8, a boss 34, a volume control switch 27, push switches 36 and 37 are mainly provided on the front side; and a boss 32 and an elongated hole 33 are mainly provided on the rear side.

The volume control switch 27 is a switch for detecting the amount of rotation.

### (About the Operation of the First Enclosure 10)

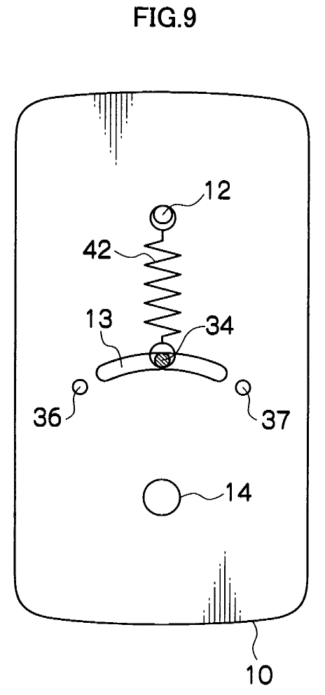

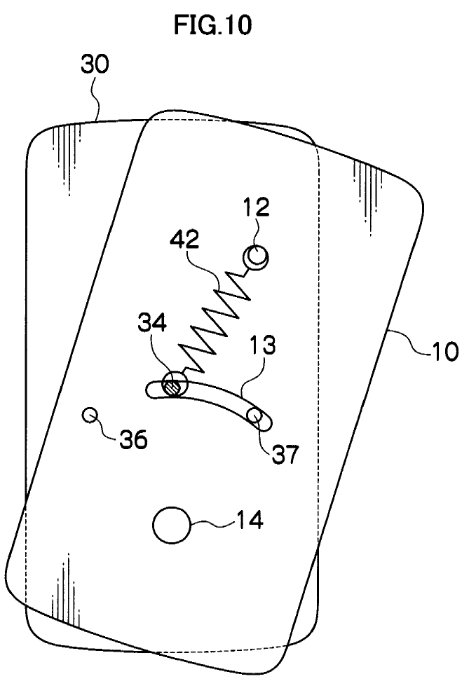

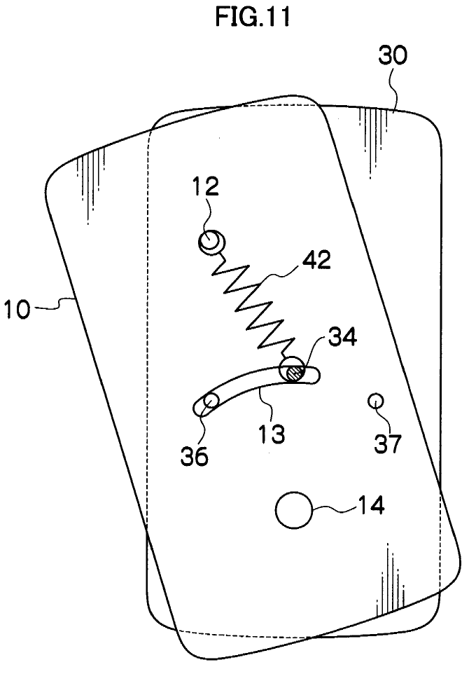

The first enclosure 10 can be subjected to the clockwise and counterclockwise rotating operations in the first position and in the second position. Hereinafter, the structure and the operation of the first enclosure 10 located in the first position will be described. FIGS. 9 to 11 are exploded perspective views of the essential portions of the digital camera 2 viewed from the front thereof. FIG. 9 illustrates a normal state in which the first enclosure 10 and the third enclosure 30 are overlapped. FIG. 10 illustrates a state in which the first enclosure 10 is rotated clockwise from the normal state. FIG. 11 illustrates a state in which the first enclosure 10 is rotated counterclockwise from the normal state.

First, the joint mechanism for rotatably jointing the first enclosure 10 and the third enclosure 30 will be described. As shown in FIG. 8, the joint mechanism is mainly composed of the boss 12, the elongated hole 13, and the shaft 14 provided on the first enclosure 10; and the boss 34, the volume control switch 27 and the spring 42 provided on the third enclosure 30.

One end of the spring 42 is fixed to the boss 12.

The hole diameter of the elongated hole 13 is larger than that of the boss 34 so as to be interlocked with the boss 34.

The shaft 14 is fitted into the volume control switch 27. Then, the volume control switch 27 can detect the rotating direction and rotation amount of the shaft 14.

The spring 42 is a coil spring for urging force in the pulling direction. One end of the spring 42 is provided on the boss 12 and the other end thereof is provided on the boss 34.

The shaft 14 is fitted into the volume control switch 27 and the boss 34 is inserted into the elongated hole 13. One end of the spring 42 is fixed to the front end of the boss 34 inserted into the elongated hole 13 and the other end of the spring 42 is fixed to the front end of the boss 12. It should be noted that when the one end of the spring 42 is fixed to the front end of the boss 34, a retaining pin, screw or the like (not shown) is attached thereto. By doing so, the first enclosure 10 and the third enclosure 30 are rotatably jointed.

In a normal state shown in FIG. 9, the spring 42 urges a force on the boss 34 so as to be located at the center of the elongated hole 13, namely, a force of holding the first enclosure 10 not to rotate clockwise or counterclockwise. For this reason, the first enclosure 10 is held in the normal state.

Next, the method of operating the first enclosure 10 will be described. As shown in FIG. 10, when a clockwise external force is applied to the first enclosure 10 against the urging force of the spring 42, the first enclosure 10 is rotated clockwise around the shaft 14 and the boss 34 slides counterclockwise along inside the elongated hole 13. When the first enclosure 10 is rotated by a predetermined angle, the pin (not shown) provided on the rear surface of the first enclosure 10 pushes the push switch 36 and the push switch 36 is turned on. Thereby, it is detected that the first enclosure 10 is rotated clockwise. At the same time, the volume control switch 27 detects the amount of rotation of the shaft 14.

Subsequently, when the clockwise external force applied to the first enclosure 10 is removed, the pulling force of the spring 42 causes the boss 34 to slide clockwise toward the center position along inside the elongated hole 13. Then, the first enclosure 10 is automatically returned to the normal state shown in FIG. 9.

As shown in FIG. 11, when a counterclockwise external force is applied to the first enclosure 10 against the urging force of the spring 42, the first enclosure 10 is rotated counterclockwise around the shaft 14 and the boss 34 slides clockwise along inside the elongated hole 13. When the first enclosure 10 is rotated by a predetermined angle, the pin (not shown) provided on the rear surface of the first enclosure 10 pushes the push switch 37 and the push switch 37 is turned on. Thereby, it is detected that the first enclosure 10 is rotated counterclockwise. At the same time, the volume control switch 27 detects the amount of rotation of the shaft 14.

Subsequently, when the counterclockwise external force applied to the first enclosure 10 is removed, the pulling force of the spring 42 causes the boss 34 to slide counterclockwise toward the center position along inside the elongated hole 13. Then, the first enclosure 10 is automatically returned to the normal state shown in FIG. 9.

Next, the operation of the digital camera 2 of the present embodiment will be described.

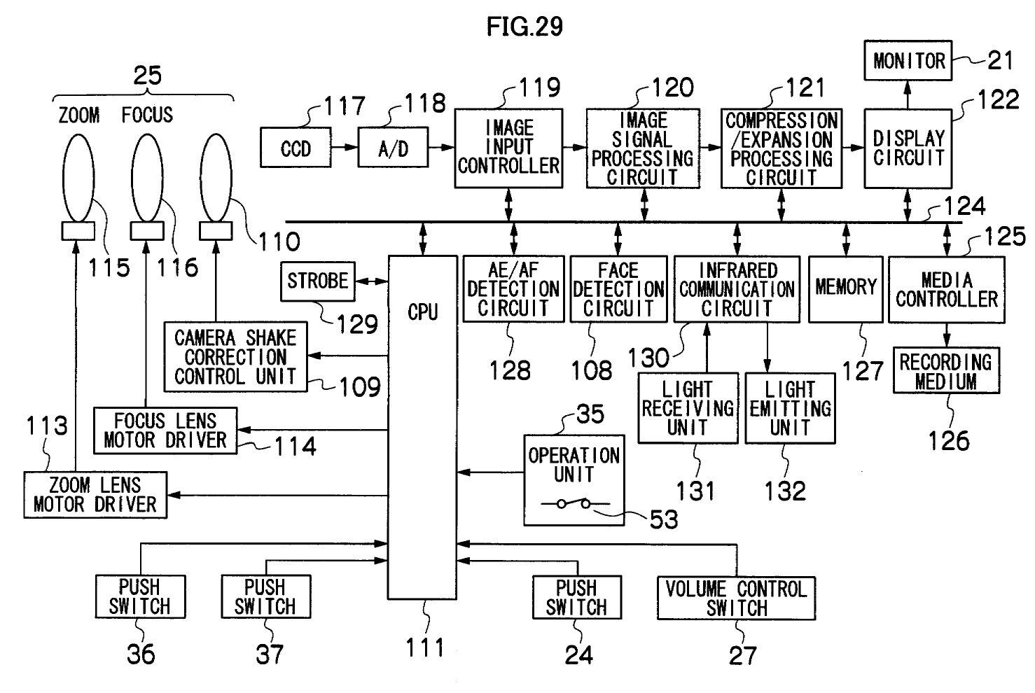

FIGS. 29 is a block diagram illustrating an embodiment of an internal configuration of the digital camera 2. The block diagram is different from that of FIG. 25 in that the volume control switch 27 is replaced by the stick switch 31, and the push switch 36 and the push switch 37 are further provided.

Each of the volume control switch 27, the push switch 36, and the push switch 37 outputs a signal according to the individual operation, and the output signal is inputted into and detected by the CPU. Therefore, as described above, the volume control switch 27 can detect the amount of rotation of the swing operation; and the push switch 36 and the push switch 37 can detect the swing direction. Further, in the same manner as in the first embodiment, the push switch 24 can detect the first position and the second position. These detection results enable the operation shown in FIG. 26. Further, as shown in FIG. 28, a function can be allocated according to the rotating direction and the rotation amount.

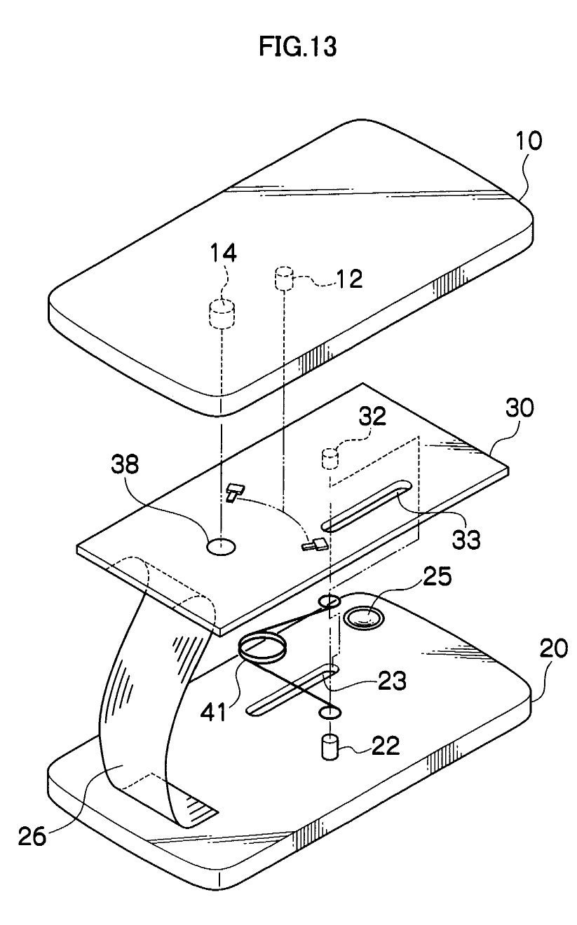

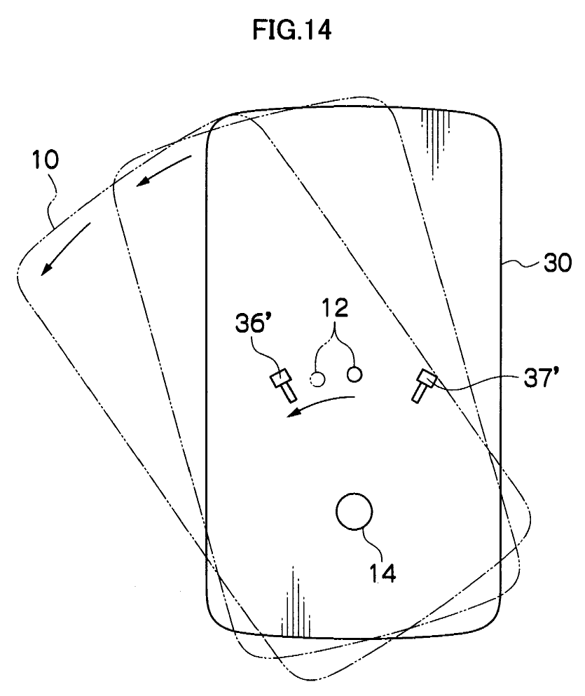

It should be noted that according to the present embodiment, the volume control switch 27, the push switch 36, and the push switch 37 are used to detect both the rotation amount and the rotating direction of the first enclosure 10, but these switches may be used to detect only the rotating direction of the first enclosure 10 and switch the function. As shown in FIG. 13, the joint mechanism is mainly composed of the boss 12 and the shaft 14 provided on the first enclosure 10; and the shaft bearing 38 provided on the third enclosure 30. The first enclosure 10 is rotatably attached to the third enclosure 30 by journaling the shaft 14 to the shaft bearing 38. As shown in FIG. 14, when the first enclosure 10 attached as above is rotated counterclockwise, the boss 12 pushes the push switch 36′, and the push switch 36′ is turned on. When the first enclosure 10 attached as above is rotated clockwise, the boss 12 pushes the push switch 37′, and the push switch 37′ is turned on. Thereby, a predetermined function can be achieved by a simple structure.

### Third Embodiment

The first embodiment of the portable device in accordance with the present invention is an embodiment in which the present invention is applied to the digital camera 1, but the present invention can be practiced by other than the digital camera.

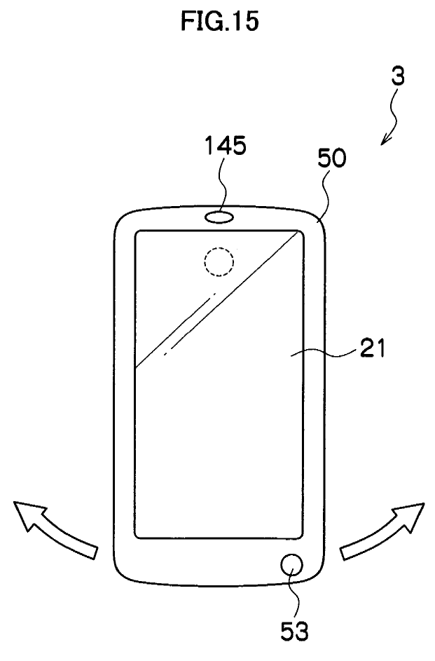

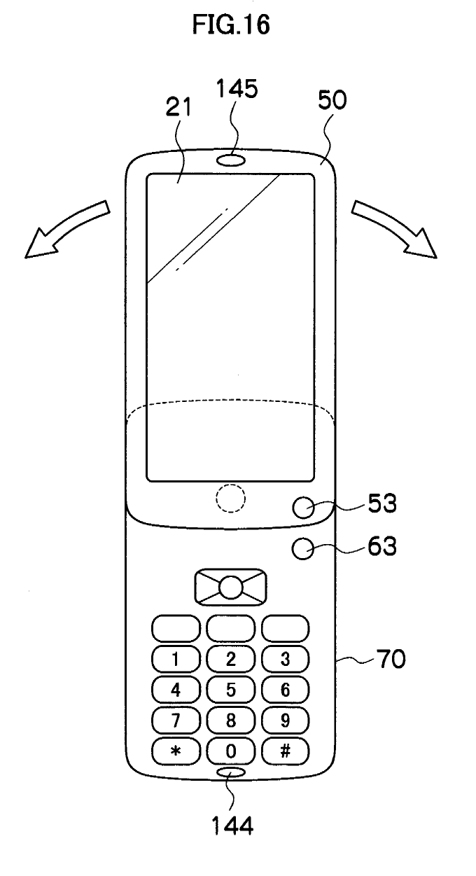

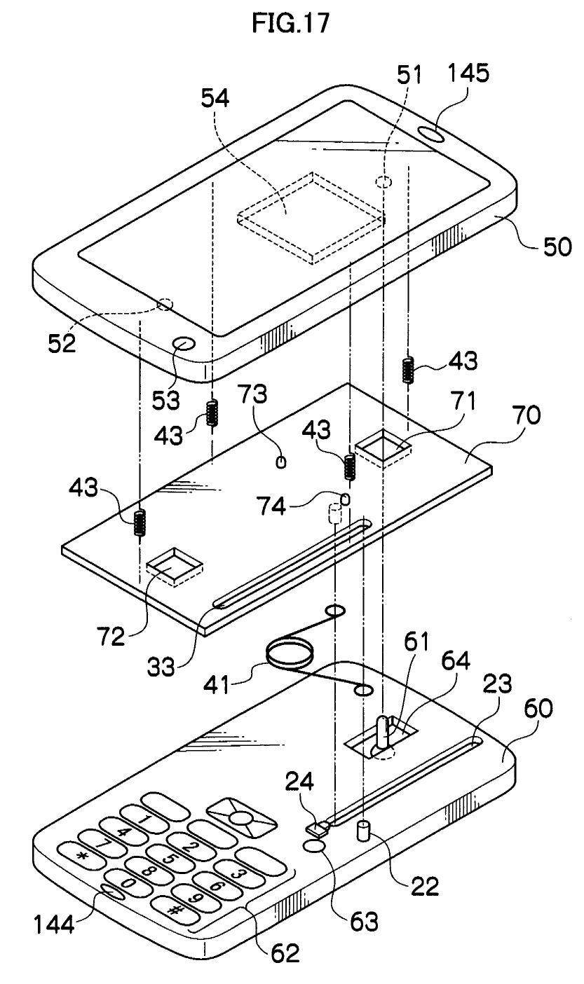

The third embodiment of the portable device in accordance with the present invention is an embodiment in which the present invention is applied to a mobile phone. FIGS. 15 and 16 are external views of the mobile phone 3 of the third embodiment in accordance with the present invention. FIG. 15 illustrates a state in which the silhouettes of the first enclosure 50, the second enclosure 60, and the third enclosure 70 are overlapped and located at the first position. FIG. 16 illustrates a state in which the first enclosure 50, the second enclosure 60, and the third enclosure 70 are moved parallel from the first position to the second position. FIG. 17 is an exploded perspective view of the essential portions of the mobile phone 3. It should be noted that the same reference numerals as in the first embodiment are assigned to the same portions and the descriptions thereof are omitted.

The mobile phone 3 is mainly composed of the first enclosure 50, the second enclosure 60, and the third enclosure 70. FIG. 15 illustrates the first position of the mobile phone 3 in a storage state in which only the monitor 21, the power button 53, and the speaker 145 are exposed. FIG. 16 illustrates the second position of the mobile phone 3 in a use state in which not only the monitor 21, the power button 53, and the speaker 145, but also the operation unit 35 including a numeric keypad 62 and a call button 63, and a microphone 144 are exposed, and communication and mailing are enabled.

The first enclosure 50 is made of a substantially rectangular member, and the monitor 21 and the power button 53 are mainly provided on the front thereof. Recessed portions 51 and 52 fitted into the front end portion of a stick switch 61 fixed to the second enclosure 60, and a recessed portion 54 having a substantially rectangular shape are provided on the rear side of the first enclosure 10.

The second enclosure 60 is made of a substantially rectangular plate shaped member having almost the same size as the first enclosure 10; and the boss 22, the elongated hole 23, the push switch 24, the stick switch 61, the numeric keypad 62, the call button 63, the elongated hole 64 and the like are mainly provided on the front thereof. It should be noted that the elongated hole 64 is formed with a width capable of detecting the left and right movement of the stick switch 61.

The third enclosure 70 is made of a substantially rectangular member smaller than the first enclosure 50 and the second enclosure 60. Push switches 73 and 74 are mainly provided on the front thereof, and the boss 32 and the elongated hole 33 are mainly provided on the rear surface. Substantially rectangular holes 71 and 72 through which a stick 61a of the stick switch 61 can pass are provided.

The stick switch 61 is composed of a stick-shaped stick 61a, and a switch unit 61b for detecting the movement of the stick 61a. The stick 61a can be rotated clockwise and counterclockwise. The front end of the stick 61a is formed into substantially I-shape to prevent rotation. The switch unit 61b can detect the rotation amount and the rotating direction of the stick 61a. It should be noted that the front end of the stick 61a may be of substantially D-shape as well as substantially I-shape.

The first enclosure 50, the second enclosure 60, and the third enclosure 70 are electrically connected to each other by a flexible printed wiring board (not shown). Moreover, the first enclosure 50 and the third enclosure 70 are jointed at four points by four springs 43 urging a pulling force. It should be noted that a restriction mechanism (not shown) is provided between the first enclosure 50 and the third enclosure 70 so as to be jointed and prevent the first enclosure 50 from rotating more than a predetermined angle with respect to the third enclosure 70.

### (About the Movement Between the First Position and the Second Position)

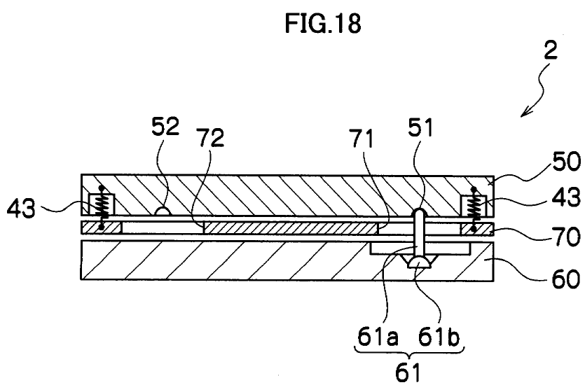

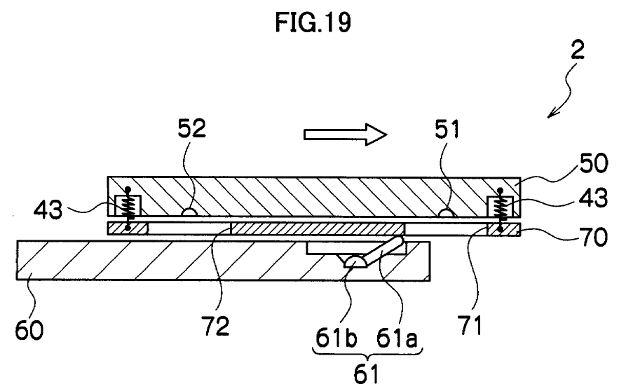

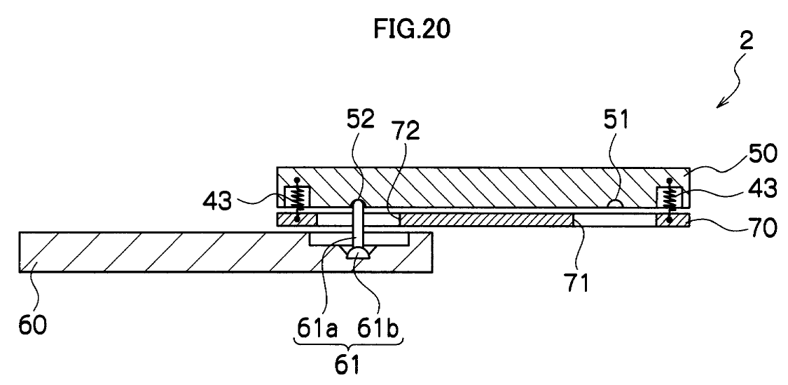

FIG. 18 is a sectional view illustrating a state in which the first enclosure 50, the second enclosure 60, and the third enclosure 70 are located at the first position. FIG. 19 is a sectional view illustrating a state in which the first enclosure 10, the second enclosure 20, and the third enclosure 30 are being moved from the first position to the second position. FIG. 20 is a sectional view illustrating a state in which the first enclosure 50, the second enclosure 60, and the third enclosure 70 are located at the second position. It should be noted that the joint mechanism for movably connecting the first enclosure 50 and the third enclosure 70 to the second enclosure 60 is the same as that in the first embodiment, and thus the description thereof is omitted.

As shown in FIG. 18, at the first position, the stick 61a passing through the hole 71 is fitted into the recessed portion 51. Thereby, the first enclosure 50, the second enclosure 60, and the third enclosure 70 are fixed at the first position.

When the first enclosure 50 and the third enclosure 70 are moved left from the first position against the urging force of the spring 41, the first enclosure 50 and the third enclosure 70 are integrally moved in parallel to the second enclosure 60. As shown in FIG. 19, when the first enclosure 50 and the third enclosure 70 are further moved, the stick 61a collapses inside the elongated hole 64 so that the second enclosure 60 can move in parallel to the rear surface of the third enclosure 70.

As shown in FIG. 20, when the first enclosure 50, the second enclosure 60, and the third enclosure 70 are moved to the second position, the stick 61a is returned to the center position and at the same time is passed through the hole 72, so that the stick 61a is fitted into the recessed portion 52. Thereby, the first enclosure 50 and the third enclosure 70 are fixed at the second position.

(About the Operation of the first Enclosure 50)

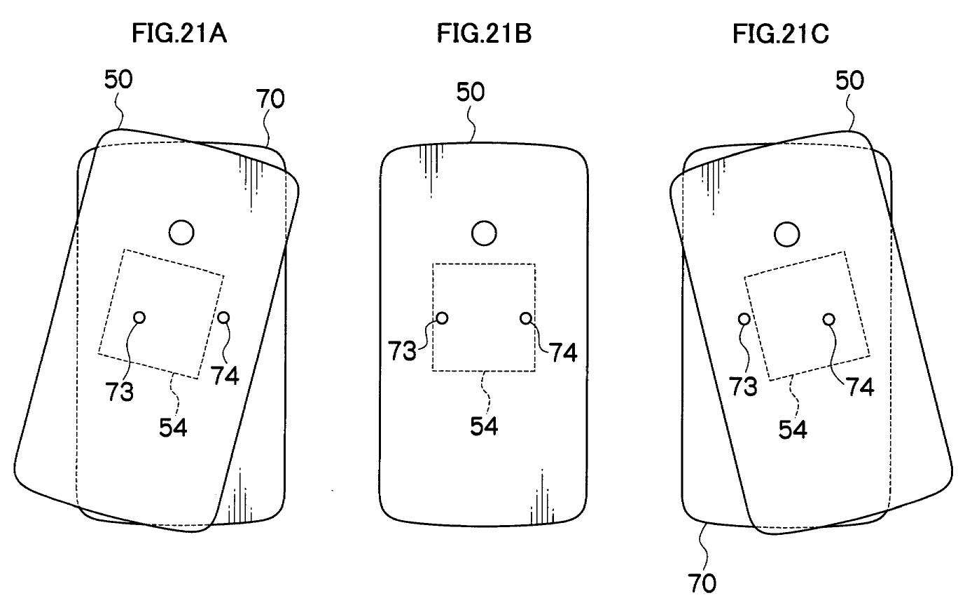

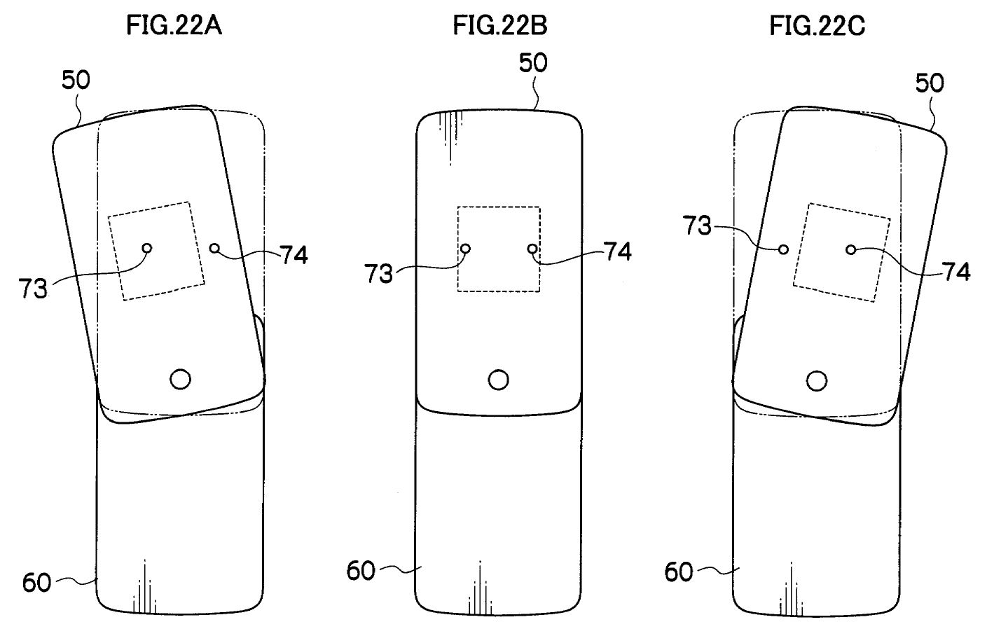

The first enclosure 50 can be subjected to a swing operation at the first position and at the second position. Hereinafter, the method of operating the first enclosure 50 at the second position will be described. FIGS. 21 and 22 are perspective views, each illustrating a state in which the first enclosure 50 is in swing operation, in which FIG. 21A and 22A illustrate a state in which the first enclosure 50 is rotated clockwise; FIG. 21B and 22B illustrate a state in which the first enclosure 50 is in the normal state; and FIGS. 21C and 22C illustrate a state in which the first enclosure 50 is rotated counterclockwise. It should be noted that FIGS. 21A, 21B, and 21C illustrate a state in which the first enclosure 50 is located at the first position; and FIGS. 22A, 22B, and 22C illustrate a state in which the first enclosure 50 is located at the second position.

First, the swing operation at the first position will be described. In the normal state shown in FIG. 21B, the push switches 73 and 74 are located under the recessed portion 54. Both the push switches 73 and 74 are turned off.

In the normal state shown in FIG. 21B, when a clockwise external force is applied to the first enclosure 50, the first enclosure 50 is rotated clockwise until the rotation is restricted by a restriction device (not shown) as shown in FIG. 21A. As the first enclosure 50 is rotated, the recessed portion 54 is rotated, and the push switch 74 is turned on from the off state. Subsequently, when the clockwise external force applied to the first enclosure 50 is removed, the urging force of the spring 43 causes the first enclosure 50 to be returned to the normal state shown in FIG. 21B.

In the normal state shown in FIG. 21B, when a counterclockwise external force is applied to the first enclosure 50, the first enclosure 50 is rotated counterclockwise until the rotation is restricted by a restriction device (not shown) as shown in FIG. 21C. As the first enclosure 50 is rotated, the recessed portion 54 is rotated, and the push switch 73 is turned on from the off state. Subsequently, when the counterclockwise external force applied to the first enclosure 50 is removed, the urging force of the spring 43 causes the first enclosure 50 to be returned to the normal state shown in FIG. 21B.

Next, the swing operation at the second position will be described. In the normal state shown in FIG. 22B, the push switches 73 and 74 are located under the recessed portion 54. Both the push switches 73 and 74 are turned off.

In the normal state shown in FIG. 22B, when a clockwise external force is applied to the first enclosure 50, the first enclosure 50 is rotated clockwise until the rotation is restricted by a restriction device (not shown) as shown in FIG. 22A. As the first enclosure 50 is rotated, the recessed portion 54 is rotated, and the push switch 74 is turned on from the off state. Subsequently, when the clockwise external force applied to the first enclosure 50 is removed, the urging force of the spring 43 causes the first enclosure 50 to be returned to the normal state shown in FIG. 22B.

In the normal state shown in FIG. 22B, when a counterclockwise external force is applied to the first enclosure 50, the first enclosure 50 is rotated counterclockwise until the rotation is restricted by a restriction device (not shown) as shown in FIG. 22C. As the first enclosure 50 is rotated, the recessed portion 54 is rotated, and the push switch 73 is turned on from the off state. Subsequently, when the counterclockwise external force applied to the first enclosure 50 is removed, the urging force of the spring 43 causes the first enclosure 50 to be returned to the normal state shown in FIG. 22B.

Next, the operation of the mobile phone 3 of the present embodiment will be described.

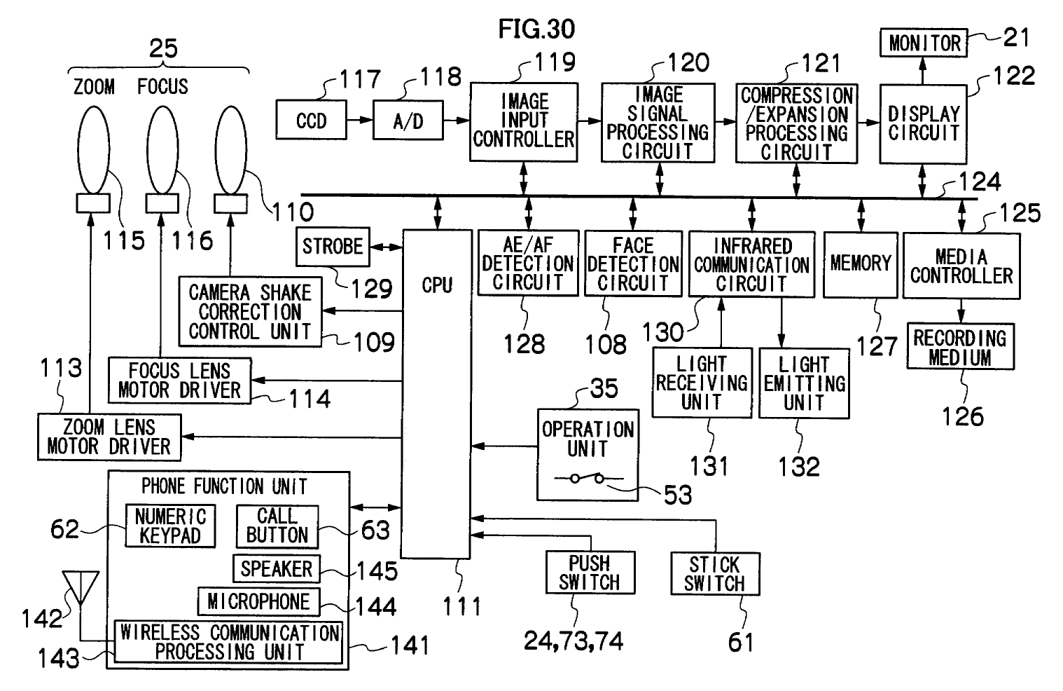

FIG. 30 is a block diagram illustrating an embodiment of an internal configuration of the mobile phone 3. It should be noted that the same reference numerals as in FIG. 25 are assigned to the same portions and the detailed descriptions thereof are omitted. The block diagram is different from the block diagram of the digital camera 1 shown in FIG. 25 in that the phone function unit 141, and the push switches 73 and 74 are further provided.

The phone function unit 141 is composed of an antenna 142 for sending and receiving a phone signal, a wireless communication processing unit 143 for controlling phone communication, a microphone 144 serving as a voice inputting device, a speaker 145 serving as a voice outputting device, and a numeric keypad 62 for allowing the user to perform various operations.

As described above, the push switches 73 and 74 detect the swing operation of the first enclosure 50. When the push switch 73 or 74 outputs an on or off signal, the CPU 111 detects the output signal and detects the swing operation of the first enclosure 50.

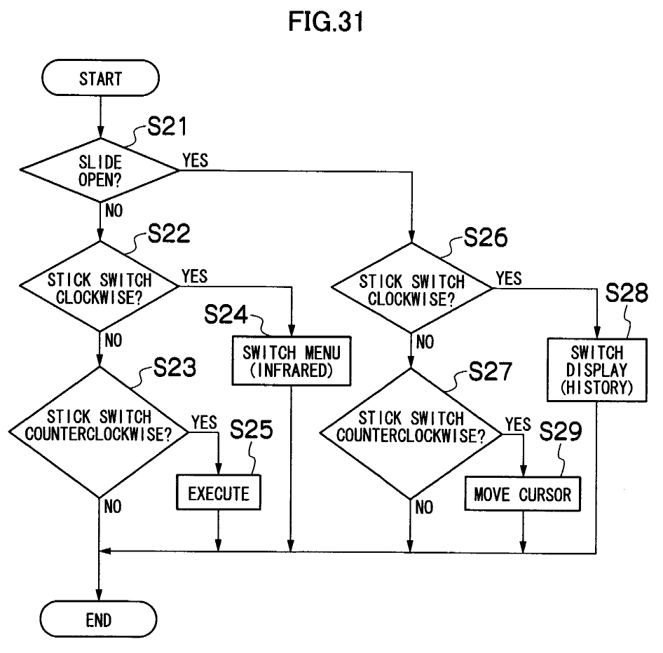

Next, with reference to FIG. 31, the operation of the mobile phone 3 will be described. FIG. 31 is a flowchart showing an operation related to the swing operation of the mobile phone 3.

The mobile phone 3 displays a standby screen in the initial state. Here, the state of the push switch 24 is detected to determine whether the mobile phone 3 is located at the first position or at the second position (step S21). If a determination is made that the push switch 24 is turned off, namely, that the mobile phone 3 is located at the first position, the swing operation is detected by the push switches 73 and 74.

At the first position, if the push switch 73 is turned off and the push switch 74 is turned on, namely, a clockwise swing operation is performed (step S22), the menu is switched to the infrared communication mode. In the state where the standby screen is displayed, when a clockwise swing operation is performed, the screen is switched to the infrared transmission mode. When a clockwise swing operation is performed in the infrared transmission mode, the screen is switched to the infrared receiving mode. Further, when a clockwise swing operation is performed in the infrared receiving mode, the screen is switched to the standby screen.

At the first position, if the push switch 73 is turned on and the push switch 74 is turned off, namely, a counterclockwise swing operation is performed (step S23), the process of sending or receiving by infrared communication is performed (step S25). For example, image data or the like on the standby screen is sent or received in the infrared communication mode.

If a determination is made that the push switch 24 is turned on, namely, the mobile phone is located at the second position, further, the push switches 73 and 74 are used to detect the swing operation.

At the second position, if the push switch 73 is turned off and the push switch 74 is turned on, namely, a clockwise swing operation is performed (step S26), the screen is switched to the history display mode. In the state where the standby screen is displayed, when a clockwise swing operation is performed, the screen is switched to the incoming call history display mode. When a clockwise swing operation is performed in the incoming call history display mode, the screen is switched to the outgoing call history display mode. Further, when a clockwise swing operation is performed in the outgoing call history display mode, the screen is switched to the standby screen.

At the second position, if the push switch 73 is turned on and the push switch 74 is turned off, namely, a counterclockwise swing operation is performed (step S27), cursor movement is performed in the displayed call history (step S29). In the incoming call history display mode and in the outgoing call history display mode, only a limited number of items can be simultaneously displayed on the monitor 21, but the cursor movement allows other history items to be displayed thereon.

What is claimed is:

1. A portable device having a first enclosure and a second enclosure, comprising:
a joint device which slidably joints the first enclosure and the second enclosure, and which enables a first operation of slidably moving the first enclosure between a first position and a second position in a same plane and enables a second operation of rotatably moving the first enclosure around a predetermined axis in the same plane based on a reference position of at least one of the first position and the second position; and
an instruction input device which inputs an instruction to the portable device based on at least the second operation of the first enclosure.

2. The portable device according to claim 1, wherein the joint device can joint self-returnably to the reference position after the second operation of rotary movement.

3. The portable device according to claim 1, wherein the joint device further comprises a device which stops the first enclosure and the second enclosure at the first position and the second position with a predetermined holding force.

4. The portable device according to claim 2, wherein the joint device further comprises a device which stops the first enclosure and the second enclosure at the first position and the second position with a predetermined holding force.

5. The portable device according to claim 1, further comprising a position detection device which detects whether the first enclosure is located at the first position or the second position, wherein the instruction input device inputs an instruction to the portable device based on a detection result of the position detection device

6. The portable device according to claim 4, further comprising a position detection device which detects whether the first enclosure is located at the first position or the second position, wherein the instruction input device inputs an instruction to the portable device based on a detection result of the position detection device

7. The portable device according to claim 1, further comprising a device which detects a rotating direction of the second operation, wherein the instruction input device inputs an instruction to the portable device based on the detected rotating direction.

8. The portable device according to claim 6, further comprising a device which detects a rotating direction of the second operation, wherein the instruction input device inputs an instruction to the portable device based on the detected rotating direction.

9. The portable device according to claim 7, further comprising a device which detects a rotating amount of the second operation, wherein the instruction input device inputs an instruction to the portable device based on the detected rotating amount.

10. The portable device according to claim 8, further comprising a device which detects a rotating amount of the second operation, wherein the instruction input device inputs an instruction to the portable device based on the detected rotating amount.

11. The portable device according to claim 9, wherein the instruction input device inputs an instruction to the portable device so as to change a speed of a function of operating based on the detected rotation amount.

12. The portable device according to claim 10, wherein the instruction input device inputs an instruction to the portable device so as to change a speed of a function of operating based on the detected rotation amount.

13. The portable device according to claim 9, wherein the instruction input device inputs an instruction to the portable device so as to change a function of operating based on the detected rotation amount.

14. The portable device according to claim 10, wherein the instruction input device inputs an instruction to the portable device so as to change a function of operating based on the detected rotation amount.

15. An imaging device comprising the portable device according to claim 1, wherein
the second enclosure is provided with a photographic lens, and
the photographic lens is covered with the first enclosure at the first position and is exposed at the second position.

16. The imaging device according to claim 15, further comprising:
a position detection device which detects whether the first enclosure is located at the first position or the second position, wherein
when the first position is detected, the instruction input device inputs an instruction related to an image reproduction, and when the second position is detected, the instruction input device inputs an instruction related to an image photographing.

17. The imaging device according to claim 15, further comprising:
a position detection device which detects whether the first enclosure is located at the first position or the second position, wherein
when the first position is detected, power supplied to the imaging device is turned off.

18. An imaging device comprising the portable device according to claim 12, wherein
the second enclosure is provided with a photographic lens, and
the photographic lens is covered with the first enclosure at the first position and is exposed at the second position.

19. The imaging device according to claim 18, wherein
when the first position is detected, the instruction input device inputs an instruction related to an image reproduction, and when the second position is detected, the instruction input device inputs an instruction related to an image photographing.

20. The imaging device according to claim 18, wherein
when the first position is detected, power supplied to the imaging device is turned off.

21. An imaging device comprising the portable device according to claim 14, wherein
the second enclosure is provided with a photographic lens, and
the photographic lens is covered with the first enclosure at the first position and is exposed at the second position.

22. The imaging device according to claim 21, wherein
when the first position is detected, the instruction input device inputs an instruction related to an image reproduction, and when the second position is detected, the instruction input device inputs an instruction related to an image photographing.

23. The imaging device according to claim 21, wherein
when the first position is detected, power supplied to the imaging device is turned off.
